(19) United States
(12) Patent Application Publication
(10) Pub. No.: US 2004/0046391 A1
(43) Pub. Date: Mar. 11, 2004

(54) Exhaust system flanges

(76) Inventor: Kailash C. Vasudeva, Waterloo (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/656,948

(22) Filed: Sep. 8, 2003

Related U.S. Application Data
(63) Continuation-in-part of application No. 09/758,311, filed on Jan. 12, 2001, now abandoned.
(60) Provisional application No. 60/176,043, filed on Jan. 14, 2000.
(60) Provisional application No. 60/194,765, filed on Apr. 3, 2000.

(51) Int. Cl. F16L 17/00

(52) U.S. Cl. 285/368; 285/422; 285/412

(57) ABSTRACT

The present invention is directed at an exhaust flange assembly comprising flanges formed by powder metallurgical methods for attachment to exhaust pipes. The first flange preferably comprising a first surface having a cavity and a pipe attachment surface opposite the first surface. The second flange comprises a sealing surface having a shape complementary to the cavity of the first flange and a pipe attachment surface opposite the sealing surface.

### REFERENCE TO RELATED APPLICATION

This is a continuation-in-part application based on and claiming the benefit of U.S. patent application Ser. No. 09/758,311, filed Jan. 12, 2001, which claims priority from U.S. provisional patent application No. 60/176,043, filed Jan. 14, 2000 and U.S. provisional patent application No. 60/194,765, filed Apr. 3, 2000.

### FIELD OF THE INVENTION

This invention relates generally to exhaust systems and more particularly mainly to an exhaust flange assembly used in exhaust systems of internal combustion engines, such as those used in automobiles and trucks.

### BACKGROUND OF THE INVENTION

In the field of exhaust systems, exhaust flanges are generally used to connect the ends of exhaust pipes to each other. In such systems, it is common to have stamped or forged and/or machined flanges which are welded to the ends of exhaust pipes which are to be joined to each other, with the flanges having flat mating surfaces which are bolted together with a gasket in between. However, there are various disadvantages of prior art exhaust flanges when the two flanges are mated.

Firstly, some prior art exhaust flanges are manufactured by a stamping process along with a machining process. However, this is quite an expensive overall process to use and maintain and requires lots of machinery and manpower to operate. Also, the use of stamping and machining does not allow for complex shapes to be manufactured at an economically feasible rate.

Another disadvantage of prior art flanges is that they are susceptible to leaks. When the flanges are mated, there generally exists small holes or paths whereby exhaust escapes out of the exhaust system and is released into the atmosphere. Furthermore, some of the leaks which appear in existing exhaust flanges are caused by flanges which are misaligned with each other such that when the flanges are mated, the faces of the flanges do not lie flat against each other. Another factor which causes the misalignment of exhaust flanges is that fastening means, in the form of studs or bolts, are not formed integral to the flanges. Instead, the studs are usually separate parts which may affect the alignment of the two flanges. Also, the studs may slip after being fastened causing the flanges to be further misaligned. Furthermore, in some prior art flanges, over-tightening of the fastening means causes the flanges to deflect away from each other thus causing leakage.

Existing exhaust flanges are also quite heavy which may affect the overall exhaust system since the heavier flanges require more support when installed. In some prior art exhaust flanges assemblies, the assemblies include gaskets which assist in the sealing process. However, some suffer from having these gaskets fall out during assembly of the system causing the system to either fail or stopped.

It is therefore, desirable to provide a novel exhaust flange assembly.

### SUMMARY OF THE INVENTION

It is an object of the present invention to obviate or mitigate at least one disadvantage of previous exhaust system flanges.

In one aspect of the invention, instead of manufacturing flanges by stamping, forging and/or machining, the flanges are formed by powder metallurgy, which offers a number of advantages, including the ability to achieve flange shapes which cannot be obtained by stamping. Furthermore, the powder metallurgy process also is more economically feasible than some prior art flange manufacturing processes.

In accordance with one aspect of an exhaust flange assembly, there are two flanges, one on the end of a first exhaust pipe and one on the end of a second exhaust pipe. The flanges have complementary shapes, such that one of the flanges, which may be seen as an “inner flange”, nests partially within the other flange, which may be seen as an “outer flange”.

In another aspect of the invention, one of the flanges, preferably the inner flange, has integral mounting studs on opposing sides of the exhaust pipe, configured to extend through corresponding holes in the outer flange. The studs are threaded to receive nuts which are tightened to draw the two flanges together for a secure connection when the flanges are mated. Furthermore, material may be added to the flanges in predetermined areas so as to reduce or eliminate the amount of deflection when the flanges are mated.

Preferably, the proximal surfaces of the flanges, i.e. the surfaces of the flanges away from their mating surfaces, comprise reinforcement ribs, which allow the overall thickness and weight of the flanges to be reduced compared to conventional flanges. As an alternative to reinforcement ribs to reduce weight, the flanges may comprises through holes formed in several locations to achieve similar weight reduction.

In a further aspect of the invention, the flanges have extensions for attachment by press-fitting, spinning, resistance welding, crimp rolling or other known processes to the exhaust pipes. Thus, no welding is necessary between the exhaust pipe and the extension other than as a further reinforcement of the joint.

Furthermore, the nesting together of the flanges provides an improved seal between the flanges, in that there is little or no escape route for exhaust gases, thus reducing the need for expensive gaskets to be placed between the flanges or perhaps eliminating the need for gaskets altogether. Also, the use of powder metallurgy allows for larger diametered studs and matching holes with close tolerances to be manufactured to form a rigid exhaust flange assembly. There may also be composite material inserted between the mating faces of the two flanges to provide further sealing properties to the exhaust flange assembly.

Another advantage of the invention is that since the mounting studs or bolts may be integral to the flanges, the exhaust flange assembly will tend to remain intact even if the nuts become loose or dislodged from the studs unlike prior art flanges whereby if the bolts fall out the connection between the two flanges shifts. One other advantage is that the nesting of one flange within the other reduces the lateral shifting of the exhaust flange assembly, even if the nuts are loose or missing, causing the exhaust flange assembly, or flange joint, to be mechanically secure.

Moreover, at least one of the flanges has an annular gasket recess located on its sealing surface. The annular gasket recess preferably has gasket retaining means, either gasket recess protrusions or the gasket recess being generally oval, for retaining the gasket by bending the substantially circular gasket to an oval shape inside the gasket recess.

In another aspect, the outer flange and the inner flange have stud mounting holes arranged to receive threaded studs onto which nuts are threadable, whereby the flanges may be drawn together for a secure connection by the nuts.

In yet another aspect of the invention, the outer flange has a curved extension protruding in a direction opposite to the cavity defined in its sealing surface, and the inner flange has a curved extension protruding in a direction opposite to its sealing surface, the extensions arranged to be fitted into the ends of exhaust pipes. Preferably, the end of the exhaust pipe is press-fitted, spun, resistance welded, crimp rolled or roll-formed to conform to the outer surface of the extensions which has a groove surrounded by an inner ridge and an outer ridge.

In another aspect, the studs, and or bolts, have generally spherical portions facing the bolt thread, the spherical portions of the bolts arranged to cooperate with generally concave recesses arranged in the flanges around mounting holes. The studs may also include hexagonal portions which prevent the stud from spinning after the flanges have been mated.

Still a further embodiment of an exhaust flange assembly, according to an aspect of the invention, comprises a straight flange cooperating with a curved flange, where an outer edge of the curved flange is bent away from the surface of the curved flange which contacts the straight flange, so that, when the straight flange is mated to the curved flange by fastening means, the curved flange deflects towards the straight flange to form a flat sealing surface, thus enhancing the seal between the curved flange and the straight flange. The curved flange is substantially weakly bowl-shaped Preferably, the straight flange and the curved flange have mounting holes and the fastening means comprise mounting studs, for placement through the mounting holes, and mounting nuts to be tightened onto each mounting stud, for drawing the straight flange and the curved flange together. In another aspect of the invention, the straight and the curved flanges have gasket recesses, for accommodating gaskets.

In a further aspect, the exhaust flange assembly has an inner flange comprising a shaped recess for receiving one side of a gasket and an outer flange comprising a cavity for receiving another side of the gasket element. When the flanges are mated, the gasket rests in between the mating surfaces of the two flanges thereby providing improved sealing characteristics for the exhaust flange assembly.

An elongated substantially flat exhaust flange, according to a further aspect of the invention, comprises a sealing surface having a cavity and a pipe attachment means, seen as an extension, arranged on a surface opposite the sealing surface.

In another aspect of the invention, there is provided a method of producing exhaust flanges comprising the steps of press-forming metal powder to shape a first substantially flat part of an inner flange; press-forming metal powder to shape a second annular sealing part of the inner flange; fitting the first part onto the second part; and sintering the first part and the second part to thereby bond them together and form the inner flange.

Advantageously, the method further comprises the step of pre-sintering the first part and the second part after press-forming but before fitting the first part onto the second part.

Preferably a weld is applied to a joint between the first part and the second part after the first part is fitted into the second part in the embodiment where the flanges are made of composite material.

A further aspect of a method of producing exhaust flanges according to the invention comprises the steps of stamping metal to shape a first part of a flange; press-forming metal powder to shape a second annular sealing part of the flange; sintering the sealing part; fitting the first part onto the second part; and joining the first part and the second part to thereby bond them together and form the flange.

A still further aspect of a method of producing exhaust flanges according to the invention comprises the steps of press-forming metal powder to shape a first substantially flat part of a flange; press-forming metal powder to shape a second annular sealing part of the flange; sintering the first part and the second part; fitting the first part onto the second part; and joining the first part and the second part to thereby bond them together and form the flange.

Preferably, the materials used for making the flanges contain 0.75 to 1 weight percent of hexagonal boron nitride (BN), which enhances the corrosion resistance properties of the powder metallurgical materials used.

Furthermore, use of a composite flange assembly permits movement between the mating surfaces of the two flanges by virtue of the shape of the complementary shapes without affecting the leak-resistant properties of the exhaust flange assembly. Therefore, even if the mated flanges move with respect to each other, little or no exhaust is lost from the exhaust system during operation.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a side view of an exhaust flange assembly having a first and second flange connected to ends of exhaust pipes;

FIG. 2 is a sectional side view of the exhaust flange assembly of FIG. 1;

FIG. 3 is a side view of the flanges of the exhaust flange assembly of FIG. 1 mated together;

FIG. 4 is a proximal end view of the first flange;

FIG. 5 is a side view of the first flange;

FIG. 6 is a distal end view of the first flange;

FIG. 7 is a distal end view of the second flange;

FIG. 8 is a side view of the second flange;

FIG. 9 is a proximal end view of the second flange;

FIG. 10 is a cross-sectional view of the second flange of FIG. 9 taken along line 10-10 on FIG. 9;

FIG. 11 is a top view of the second flange;

FIG. 12 is a distal end view of a second embodiment of the first flange;

FIG. 13 is a side view of the first flange of FIG. 12;

FIG. 14 is a proximal end view of the first flange of FIG. 12;

FIG. 15 is a proximal end view of another embodiment of a second flange;

FIG. 16 is a side view of the second flange of FIG. 15;

FIG. 17 is a distal end view of the second flange of FIG. 15;

FIG. 18 is a proximal end view of another embodiment of a first flange for mating with the second flange of FIG. 15;

FIG. 19 is a side view of the first flange of FIG. 18;

FIG. 20 is a distal end view of the first flange of FIG. 18;

FIG. 21 is a side view of an exhaust flange assembly comprising the first flange of FIG. 15 and the second flange of FIG. 18;

FIG. 22 is a side view of FIG. 21 with the first and second flanges mated;

FIG. 23 is a sectional side view of FIG. 22;

FIG. 23A is a side view of a further embodiment of an exhaust flange assembly;

FIG. 23B is a side view of yet another embodiment of an exhaust flange assembly;

FIG. 24 is a distal end view of another embodiment of a flange for use in an exhaust flange assembly;

FIG. 25 is a cross-sectional view of the flange of FIG. 24 taken along the line 25-25 of FIG. 24;

FIG. 26 is a side view of a further embodiment of an exhaust flange assembly;

FIG. 27 is an exploded partially sectioned side view of another embodiment of an exhaust flange assembly;

FIG. 28 is an exploded partially sectioned side view of yet another embodiment of an exhaust flange assembly;

FIG. 29 is a sectional side view of the exhaust flange assembly of FIG. 28 with the flanges mated;

FIG. 30A is a side view of another embodiment of first and second flanges of an exhaust flange assembly;

FIG. 30B is a sectional side view of the flanges of FIG. 30A;

FIG. 31A is a distal end view of another embodiment of a flange for use in an exhaust flange assembly;

FIG. 31B is a cross-sectional view of the flange of FIG. 31A taken along line 31B-31B of FIG. 31A;

FIG. 32A is a distal end view of yet another embodiment of a flange for use in an exhaust flange assembly;

FIG. 32B is a cross-section view of the flange of FIG. 32A taken along line 32B-32B of FIG. 32A;

FIG. 33 is a sectioned side view of a further embodiment of an exhaust flange assembly without the exhaust pipes;

FIG. 34 is a sectioned side view of another embodiment of an exhaust flange assembly without the exhaust pipes;

FIG. 35 is a sectional side view of another embodiment of an exhaust flange assembly without the exhaust pipes;

FIG. 36 is a partially sectioned side view of another embodiment of an exhaust flange assembly;

FIG. 37 is a sectioned side view of the gasket of FIG. 36;

FIG. 38 is a front view of the gasket of FIG. 36;

FIG. 39A is a distal view of a further embodiment of a first flange;

FIG. 39B is a cross-sectional view of the first flange of FIG. 39A taken along line 39B-39B of FIG. 39A;

FIG. 40A is a distal view of a further embodiment of a second flange;

FIG. 40B is a cross-sectional view of the second flange of FIG. 40A taken along line 40B-40B of FIG. 40A;

FIG. 41 is a sectioned side view of another embodiment of an exhaust flange assembly;

FIG. 42 is a side view of the exhaust flange assembly (with exhaust pipes) of FIG. 41;

FIG. 43A is a front view of yet another embodiment of a first flange;

FIG. 43B is a cross-sectional view of the first flange of FIG. 43A taken along line 43B-43B of FIG. 43A;

FIG. 44A is a front view of another embodiment of a first flange;

FIG. 44B is a cross-sectional side view of the first flange of FIG. 44A taken along line 44B-44B of FIG. 44A;

FIG. 45 is an exploded side view of a further embodiment of an exhaust flange assembly without exhaust pipes;

FIG. 46 is a sectioned side view of the second flange of FIG. 45;

FIG. 47 is a sectioned side view of another embodiment of an exhaust flange assembly;

FIG. 48A is a sectioned side view of another embodiment of a first flange;

FIG. 48B is a sectioned side view of the first flange of FIG. 48A;

FIG. 49 is a flow diagram showing a method of manufacturing a flange;

FIG. 50 is a flow diagram showing a second method of manufacturing a flange;

FIG. 51 is a flow diagram showing a third method of manufacturing a flange;

FIG. 52 is a flow diagram showing a fourth method of manufacturing a flange;

FIG. 53 is a schematic view of an angled flange assembly;

FIG. 54 is a schematic view of the flange assembly of FIG. 53 with the flanges mated;

FIG. 55 is a schematic view of a further angled flange assembly;

FIG. 56 is a schematic view of the flange assembly of FIG. 55 with the flange connected to an exhaust pipe;

FIG. 57 is a schematic view of a yet another angled flange assembly;

FIG. 58 is a schematic view of the flange assembly of FIG. 57 with the flange connected to an exhaust pipe;

FIG. 59 is a schematic view of another angled flange assembly;

FIG. 60 is a schematic view of the flange assembly of FIG. 59 fully assembled;

FIG. 61 is a schematic view of a further angled flange assembly;

FIG. 62 is a schematic view of the flange assembly of FIG. 61 with the flange connected to an exhaust pipe;

FIG. 63 is a schematic view of a further embodiment of an exhaust flange assembly;

FIG. 64 is a schematic view of yet another embodiment of an exhaust flange assembly;

FIG. 65 is a schematic view of the embodiment of FIG. 64 with spacers mounted in the first flange;

FIG. 66 is a schematic view of a further embodiment of an exhaust flange assembly; and

FIG. 67 is a schematic view of the embodiment of FIG. 66 with spacers mounted in the first flange.

### DETAILED DESCRIPTION

Generally, the present invention provides an improved exhaust flange assembly for exhaust systems.

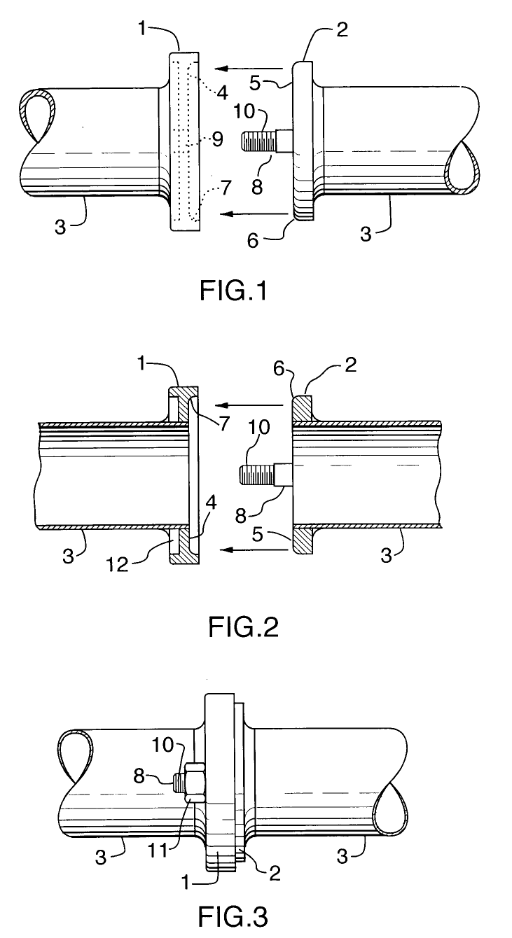

FIG. 1 shows an exhaust flange assembly, or flange joint, having a first flange 1, seen as an outer flange, and a second flange 2, seen as an inner flange, both manufactured via a powder metallurgy process and connected to ends of exhaust pipes 3. The outer flange 1 comprises a cavity 4 with a rounded edge 7 defined in its distal, or mating, surface while the inner flange 2 comprises an abutment comprising a generally flat distal surface 5 with a rounded edge 6 complementary to the rounded edge 7 of the cavity 4 thereby providing improved sealing characteristics, seen as a sealing seat, for the exhaust flange assembly. In the present embodiment, due to the complementary shapes of the rounded edges 6 and 7, there is little or no path for exhaust travelling in the pipes 3 to enter into the atmosphere, which reduces or eliminates the need for a gasket in between the two flanges 1 and 2. If a gasket is required, a less expensive gasket may be used in order to lower overall costs.

Although in this embodiment, the edges are rounded, other edge shapes for the flanges are contemplated provided they are complementary with each other. For example, the edge shape of one flange could be a sharp edge, a radius, a chamfer or a dome while the edge shape of the other flange is complementary to the selected shape.

As further shown in FIGS. 1, 2 and 11, the inner flange 2 has integral mounting studs 8 on opposing sides, configured to extend through corresponding holes 9 in the outer flange 1. After the inner flange 2 is manufactured using powder metallurgy, the studs 8 are tapped to provide threads 10. Preferably, the studs 8 comprise bolstered heads (not shown) which provide extra strength to the stud 8. As shown in FIG. 3, nuts 11 are used to tighten onto the threads 10 of the studs 8 in order to draw the outer flange 1 and the inner flange 2 together for a secure and sealed connection when the flanges are mated.

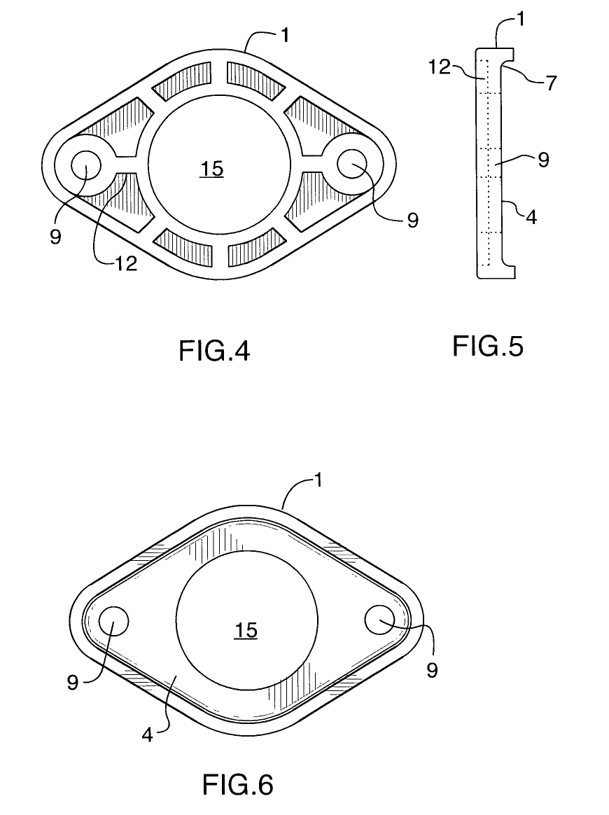

Turning to FIG. 4, a proximal end view of the outer flange 1 is shown. As discussed above, the outer flange 1 comprises holes 9 which receive the studs 8 of the inner flange 2 when the flanges are mated. Preferably, the proximal surface of the outer flange 1, the surface away from the mating surface, comprises a set of reinforcement ribs 12 which allow the overall thickness and weight of the outer flange 1 to be reduced compared to conventional flanges. FIG. 5 is a side view of the outer flange 1 with the cavity 4, the rounded edge 7, the holes 9 and the set of ribs 12 shown in dotted lines while FIG. 6 is a distal end view of the outer flange 1 showing the cavity 4, the holes 9 and a location 15 for the exhaust to flow from the flange to the exhaust pipe 3.

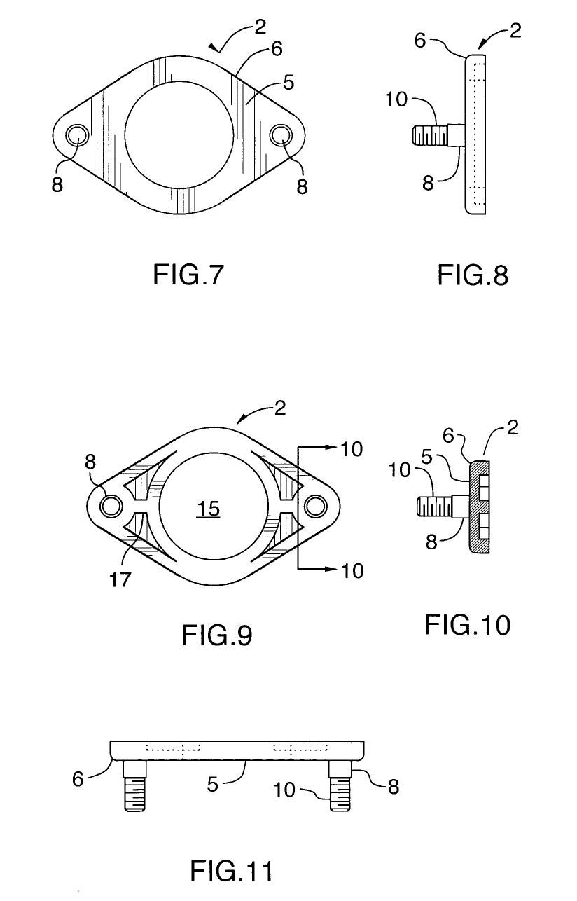

Turning to FIGS. 7 to 11, more detailed schematics of the inner flange 2 are shown. FIG. 7 is a distal end view of the inner flange 2 showing the studs 8 along with the rounded edge 6 of the distal surface 5. FIG. 8 is a side view of the inner flange 2 in which the rounded edge 6 may be more clearly seen along with the studs 8 with threads 10. FIG. 9 is a proximal view of the inner flange 2 showing the studs 8 connected, via a set of ribs 17, to a location 15 for the exhaust to flow. The ribs 17 of the inner flange 2 provide similar advantages to the set of ribs 12 described with respect to the outer flange 1. FIG. 10 is a cross-sectional view taken along the line 10-10 of FIG. 9 showing the inner flange 2 in more detail while FIG. 11 is a top view of the inner flange 2 showing the studs 8 on opposite sides of the flange 2 along with the distal, or mating, surface 5 and rounded edge 6.

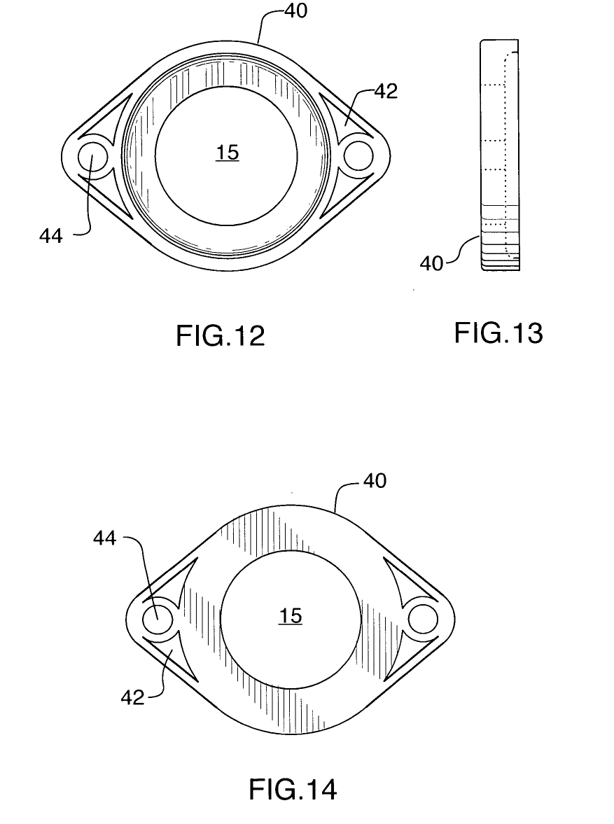

Turning to FIGS. 12 to 14, a second embodiment of an outer flange 40 is shown. In this embodiment, the outer flange 40 is almost identical to the outer flange 1 with the difference being that the outer flange 40 comprises through holes 42 formed in several locations to provide weight reduction to the outer flange 40. The through holes 42 provide similar advantages to the set of ribs 12 shown in FIG. 4. The outer flange 40 also comprises a set of holes 44 for receiving studs 8 from a complementary inner flange. Although not shown, an exhaust pipe is connected to the flange 40 at the location 15 where the exhaust flows through the flange 40. It will be understood that the inner flange may include a set of through holes instead of the set of ribs.

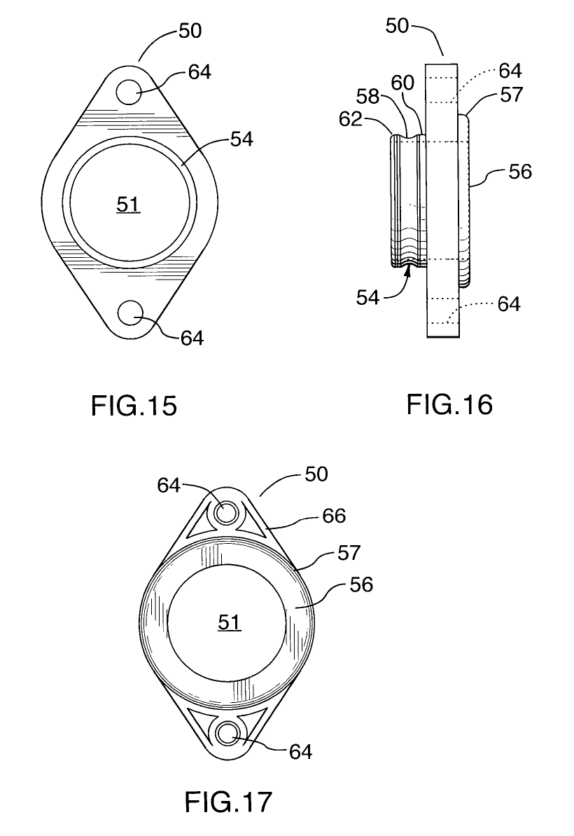

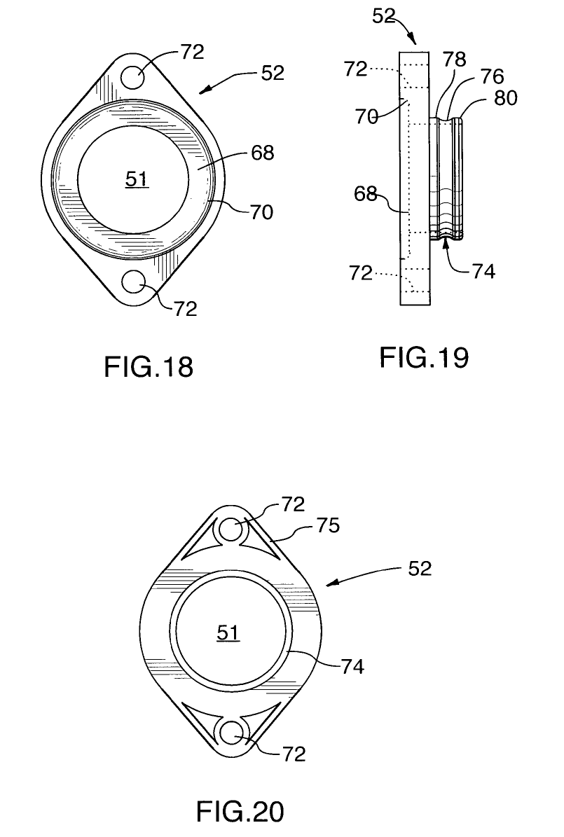

FIGS. 15 to 17 show a further embodiment of a second, or inner, flange 50 which is manufactured via a of powder metallurgy process which may be attached by press-fitting, spinning, resistance welding, crimp rolling to an end of an exhaust pipe while FIGS. 18 to 20 show an alternative embodiment of a first, or outer, flange 52 for mating with the inner flange 50.

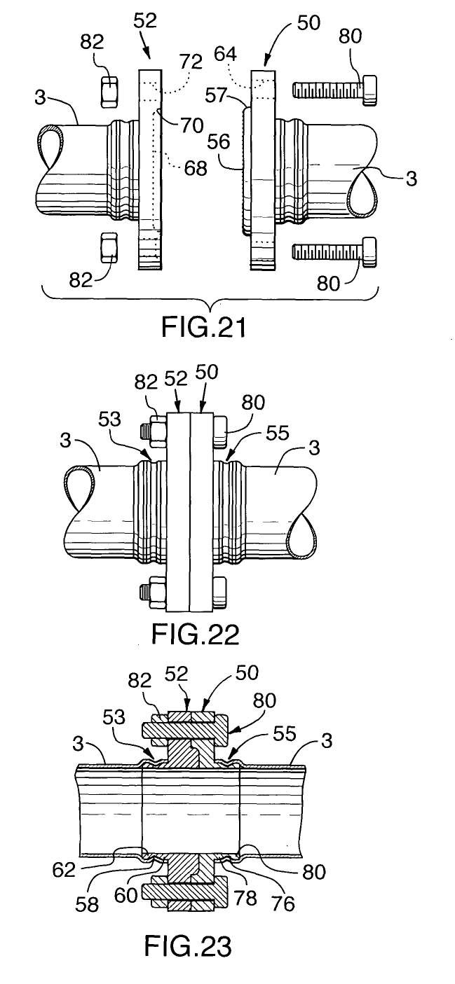

The inner flange 50 comprises a distal, or mating surface 56 with a rounded edge abutment 57 and an extension 54 arranged on the side opposite the distal surface 56. The extension 54 has a co-axial hole, corresponding to a hole 51 in an exhaust pipe 3, through which exhaust gases flow when the flanges of the exhaust flange assembly are mated, and in use. The extension 54 also comprises a substantially smooth inner surface and a grooved outer surface having a groove 58 surrounded by an inner ridge 60 and an outer ridge 62. The outer diameter of the extension 54 is preferably smaller than the inner diameter of the exhaust pipe 3 so that when the exhaust pipe 3 is attached over the extension 58, the exhaust pipe 3 is roll-formed or spin-welded to conform to the profile of the extension defined by the groove 58, the inner ridge 60 and the outer ridge 62. In this manner, the exhaust pipe 3 is held securely to the inner flange 50. This may be more clearly seen with respect to FIGS. 21 to 23.

The groove 58 may also have a variety of profile shapes, to accommodate fitting of the pipe either by induction heating or resistance welding and its shape is thus determined by the assembly process or method.

Furthermore, the extension 54 may be tapered, having an inner ridge 60 which is larger than the outer ridge 62 which causes the groove 58 to be optional. Pressing the exhaust pipe 3 onto the extension 54 may then be performed by using a lubricant or by inductively heating the exhaust pipe 3.

The inner flange 50 further comprises a pair of holes 64 for receiving fastening means which secure the connection between the inner flange 50 and the outer flange 52 when the two flanges are mated. Through holes 66 are also formed in several locations to provide weight reduction to the inner flange 50.

Turning to FIGS. 18 to 20, schematic views of another embodiment of the outer flange 52 are shown. The outer flange 52 comprises a cavity 68, defined in its distal surface, with a rounded edge 70. The distal surface 56 of the inner flange 50 nests in the cavity 68 with the rounded edge abutment 57 complementing the rounded inner edge 70 of the cavity 68 to provide a sealing seat.

The outer flange 52 further comprises a pair of holes 72 for receiving fastening means and an extension 74 arranged on a side of the flange 52 opposite the cavity 68. Through holes 75 are formed in several locations to provide weight reduction to the outer flange 52.

As with the inner flange 50, the extension 74 has a co-axial hole 51, corresponding to the hole in the outer flange 52, through which exhaust gases flow when the flange assembly is in use and a substantially smooth inner surface and a grooved outer surface having a groove 76 surrounded by an inner ridge 78 and an outer ridge 80 with the diameter of the ridges 78 and 80 of the extension being smaller than the inner diameter of the exhaust pipe 3. As with the inner flange 50, when the exhaust pipe 3 is attached to the extension 74 of the outer flange 52, the exhaust pipe 3 is roll-formed or spin-welded over the extension to conform to the profile of the extension 74.

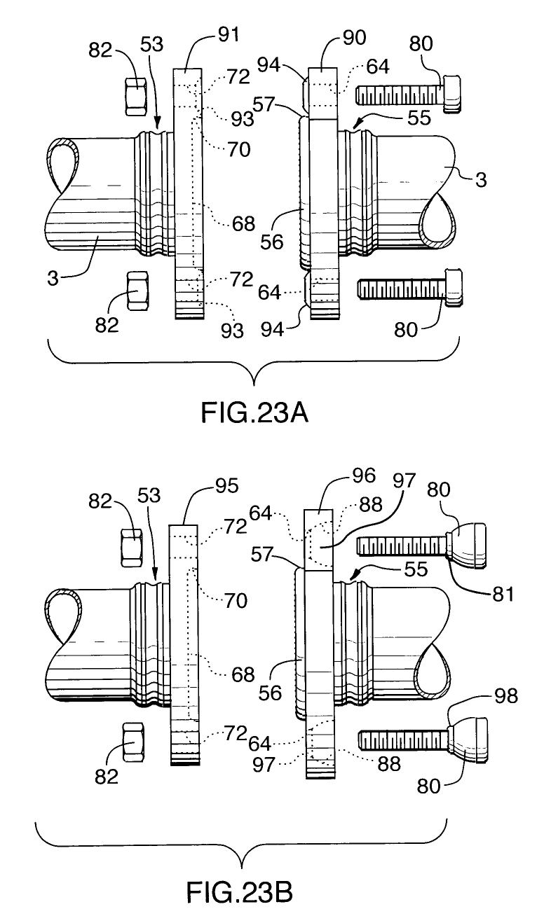

FIG. 21 provides a side view of an exhaust flange assembly, or flange joint, comprising the inner flange 50 and the outer flange 52. FIGS. 22 and 23 are side views of the exhaust flange assembly with the inner flange 50 and outer flange 52 mated.

When the exhaust pipe 3 is attached to the inner flange 50, a joint 55 is formed between the pipe 3 and the inner flange 50. A similar joint 53 is formed between the exhaust pipe 3 and the outer flange 52 when they are attached. As can be seen in FIG. 23, the exhaust pipe 3 is secured around the inner ridge 60 and the outer ridge 62 of the inner flange 50 to form the joint 55 and a second exhaust pipe is secured around the inner ridge 78 and the outer ridge 80 of the outer flange 52 to form the joint 53.

When the two flanges 50 and 52 are mated, the mounting holes 64 on the inner flange 50 and the mounting holes 72 on the outer flange 52 receive fastening means, generally comprising a bolt 80 and nut 82. A bolt 80 is inserted through each of the mounting holes 64 and 72 and a nut 82 is placed on the end of the bolt 80 and tightened onto the threads in order to draw the two flanges together and to secure the connection between the inner flange 50 and the outer flange 52. Alternatively, one of the flanges may comprise integral mounting studs configured to extend through the mounting holes in the other flange.

FIG. 23A provides a further embodiment of an exhaust flange assembly comprising an inner flange 90 and an outer flange 91.

In this embodiment, the outer flange 91 is almost identical to the outer flange 52 with the addition of a pair of recesses 93 formed on the mating surface of the outer flange 91 having a shape generally complementary to a pair of projections 94 located on the inner flange 90 to facilitate alignment of the two flanges for mating. Advantageously, the projections 94 and the recesses 93 are arranged concentrically to the mounting holes 64 and 72 of the inner and outer flanges 90 and 91, respectively.

FIG. 23B is yet another embodiment of an exhaust flange assembly comprising further embodiments of an outer flange 95 and an inner flange 96. In this embodiment, the outer flange 95 is identical to the outer flange 52 described above. In this embodiment, the inner flange 96 comprises recesses 97 arranged on the proximal side of the inner flange 96. The recesses 97 have generally concave surfaces, to cooperate with bolts 80, which preferably have heads with generally spherical lower portions to securely hold the bolt once it has been tightened into the mounting holes 64 and 72. Thus, the bolt 80 may swivel in the holes 64 and 72, to facilitate alignment of the flanges when mated. Advantageously, the inner flange 96 has an increased thickness, compared to the outer flange 95, to provide strength to compensate for the recess 97. Furthermore, the bolts 80 have a substantially cylindrical extension 98 for the bolt head so that the extension 98 has a diameter which is larger than the diameter of the threaded portion of the bolt to prevent the bolt from sliding through the recess 97 and/or mounting hole 64.

In an alternative embodiment, the extension 98 may be hexagonally shaped so that when the flanges are mated and the fastening means are fastened, the bolt does not spin during the tightening process.

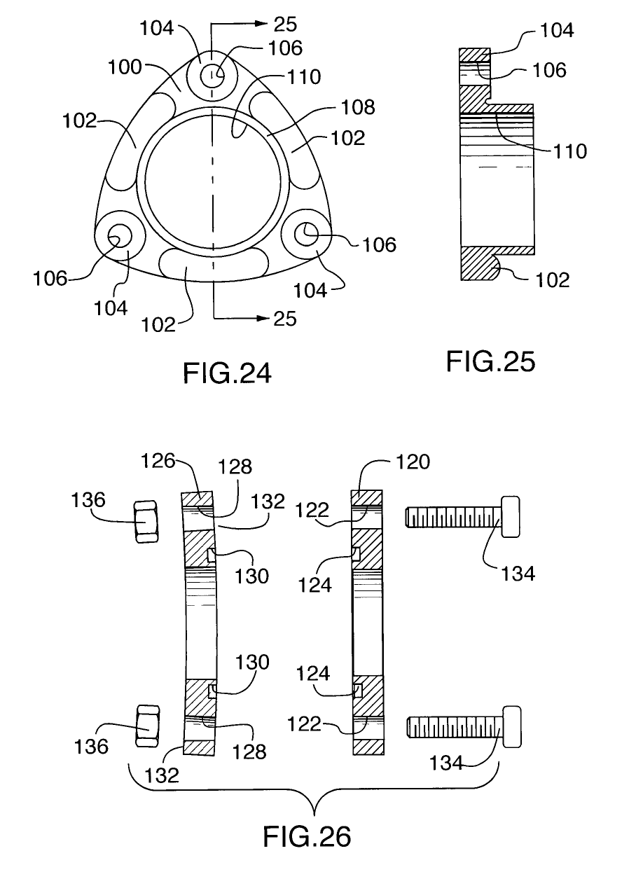

FIGS. 24 and 25 show another embodiment of a flange 100. As will be described, the flange 100 may be used as both an inner flange and an outer flange. The flange 100 comprises raised areas 102 arranged between mounting studs 104 having mounting holes 106. The raised areas 102 provide reinforcement for the flange 100 to reduce deflection of the flange 100 when the flange 100 is securely connected to another flange 100 using fastening means such as a bolt and nut. The flange 100 has a substantially cylindrical flange extension 108, with an inner diameter 110, for attachment of the flange 100 to an exhaust pipe (not shown). FIG. 25 is a cross-section of the flange 100 taken along the line 25-25 of FIG. 24.

FIG. 26 shows still a further embodiment of an exhaust flange assembly. A first flange 120, seen as a straight flange, comprising mounting holes 122 and gasket recesses 124, mates with a second flange 126, seen as a curved flange, comprising mounting holes 128 and gasket recesses 130. The curved flange 126 is substantially bowl-shaped with an outer edge 132, bent away from the mating surface of the curved flange 126. Thus, when fastening means in the form of mounting bolts 134 are placed through the mounting holes 122 of the straight flange 120 and the mounting holes 128 of the curved flange 126, and a mounting nut 136 tightened onto the threads of each mounting bolt 134, the curved flange 126 deflects towards the straight flange 120 to form a flat sealing surface which improves the sealing properties and reduces the likelihood of exhaust entering the atmosphere. This enhances the seal between the two flanges 120 and 126 and reduces further outward deflection of the curved flange 126 after the mounting nuts 136 are tightened onto the mounting bolds 134. Although not shown, the exhaust flange assembly further comprises a gasket which is retained in the gasket recesses 124 and 130 of the flanges.

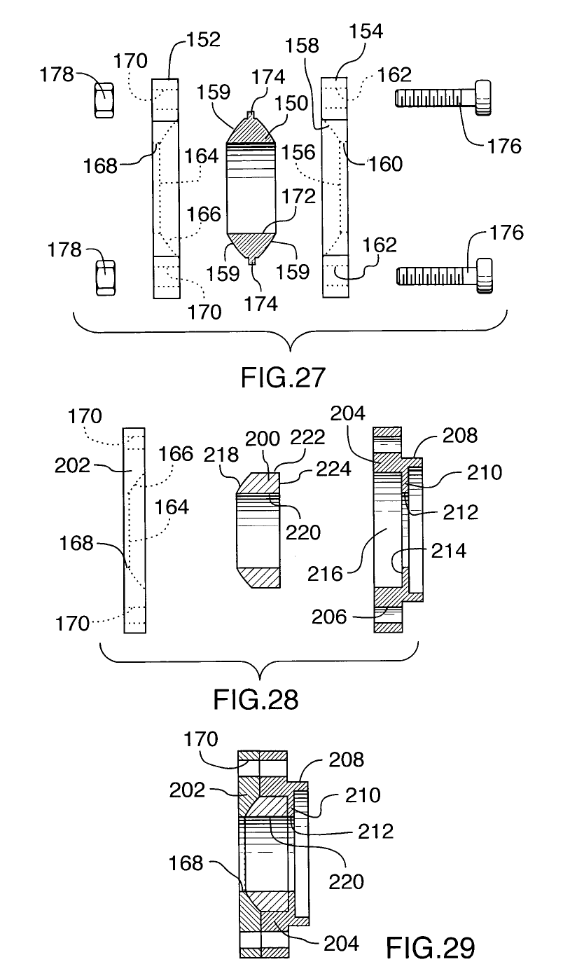

FIG. 27 shows yet a further embodiment of an exhaust flange assembly. The assembly comprises a gasket element 150 arranged between a second flange 154 and a first flange 152. The second flange 154 comprises a recess 156 with sloping side walls 158, which generally conform in shape to a curved surface 159 of the gasket element 150 having an inner diameter 160. The second flange 154 also comprises mounting holes 162. Similarly, the first flange 152 comprises a recess 164 with sloped side walls 166, which generally conform in shape to the curved surface 159 of the gasket element 150 having an inner diameter 168. The first flange 152 also comprises mounting holes 170.

The gasket element 150 has an inner diameter 172, substantially the same as inner diameters 160 and 168 and further comprises a flange gap defining protrusion 174 arranged along its circumference. When fastening means, in the form of mounting bolts 176, are inserted into the mounting holes 162 and 170 of the second and first flanges 154 and 152, respectively, and a mounting nut 178 is tightened onto each mounting bolt 176, the two flanges 152 and 154 are drawn together and compress the gasket element 150, which reduces the amount of amount of float (relative movement of the flanges) to provide an enhanced leak resistance and therefore improved sealing characteristics for the exhaust flange assembly. Also, the complementary shape of the mating surface of the flanges allows for the flanges to move with respect to each other however, retaining their sealing properties. In operation, the exhaust flows from the exhaust pipe through the inner diameters of the flange assembly to an exhaust pipe at the other end of the assembly.

FIGS. 28 and 29 show a further embodiment of an exhaust flange assembly comprising a composite gasket element 200 arranged between a second flange 204 and a first flange 202. The first flange 202 is identical to the first flange 152 of FIG. 27 while the second flange 204 comprises mounting holes 206 and a substantially cylindrical flange extension 208 for attachment to an exhaust pipe (not shown). Further, the second flange 204 has a backing plate portion 210 arranged on the same side of the flange as the flange extension 208. The backing plate portion 210 has an inner diameter 212 and an inner surface 214, facing away from the flange extension side of the flange 204. The inner surface 214 of the flange 204 is larger than the inner diameter 212 of the backing plate portion 210. The composite gasket element 200 has a curved surface 218, generally conforming in shape to the recess 164 and the sloping side walls 166 of the first flange 202 and has an inner diameter 220, substantially the same as the inner diameters 168 and 212 of the first and second flanges 202 and 204, respectively. The gasket element 200 further comprises an outer surface 222 and a substantially flat surface facing the second flange 204. When mounting bolts (not shown) are inserted into the mounting holes 206 and 170, and a mounting nut (not shown) is tightened onto each mounting bolt, the two flanges compress the gasket element 200 to provide an enhanced leak resistance for the flange assembly. The backing plate portion 210 retains the composite seal between the second flange 204 and the composite gasket element 200. FIG. 29 shows the second flange 204 and the first flange 202 mated with the gasket 200 there between. In operation, the exhaust flows from the exhaust pipe through the inner diameters of the flange assembly to an exhaust pipe at the other end of the assembly.

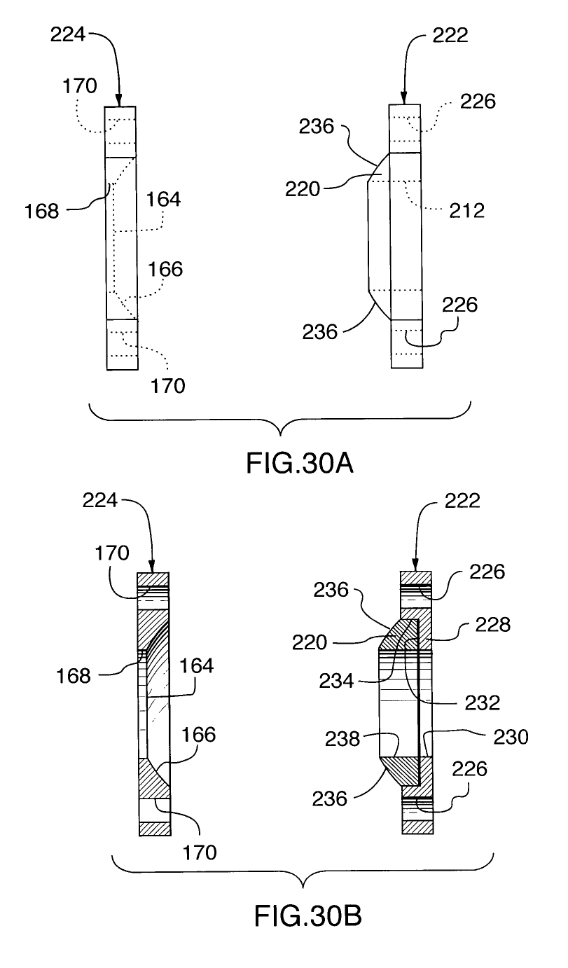

FIGS. 30A and 30B show a further embodiment of an exhaust flange assembly similar to the embodiments shown in FIGS. 27 to 29. A composite gasket element 220 is bonded to a second flange 222, seen as an inner flange, by pressing and sintering the gasket element 220 and the flange 222 in one sintering step, or by sintering the inner flange 222 first then inserting the pressed gasket element 220 and sintering again. The composite gasket element 220 is arranged between a first, or outer, flange 224 (similar to the first flange 152 as described in FIG. 27) and the inner flange 222. The inner flange 222 has mounting holes 226 and a backing plate portion 228 arranged on the side of the flange away from the gasket 220. The backing plate portion 228 has an inner diameter 230 and an inner surface 232 facing away from the backing plate portion 228. The inner flange 222 has a general inner diameter 234, which is larger than the inner diameter 230 of the backing plate portion 228.

The composite gasket element 220 has a curved surface 236, generally conforming in shape to the recess 164 and sloping side walls 166 of the first flange 224. The composite gasket element 220 further comprises an inner diameter 238, substantially the same as the inner diameters 230 and 168 through which the exhaust flows.

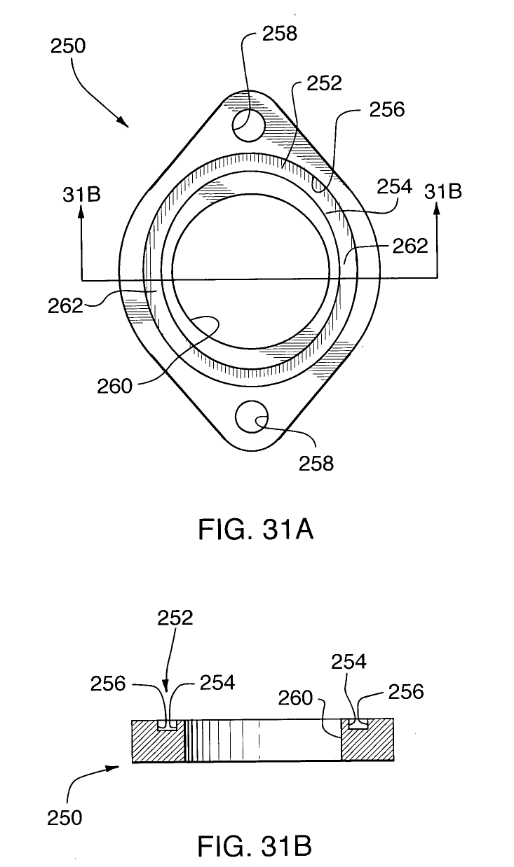

FIGS. 31A and 31B show yet another embodiment of a unisex flange 250 which may be used as both the first and second flanges of an exhaust flange assembly. The flange 250 comprises an annular gasket recess 252, which has an inner wall 254 and an outer wall 256. Further, the flange 250 has mounting holes 258, and an inner diameter 260. The inner wall 254 and the outer wall 256 form at least one squeeze area 262, where the width of the gasket recess (the distance between the outer wall and the inner wall) is substantially narrower than a maximum gasket recess width (substantially equal to the diameter of the inner wall 254). In this manner, the gasket is formed to fit within the groove with the four pressure points, squeeze areas, providing the pressure to retain the gasket. In other words, the generally circular gasket is stretched to fit over the substantially oval gasket recess 252 whereby the stretching of the gasket creates squeeze areas in its circumference which serve as pressure points for retaining the gasket on the gasket recess. The gasket (not shown) is also held in the gasket recess 252 after being inserted. Preferably, two such squeeze areas 262 are defined in the gasket recess 252. FIG. 31B is a cross-sectional view taken along the line 31B-31B of FIG. 31A.

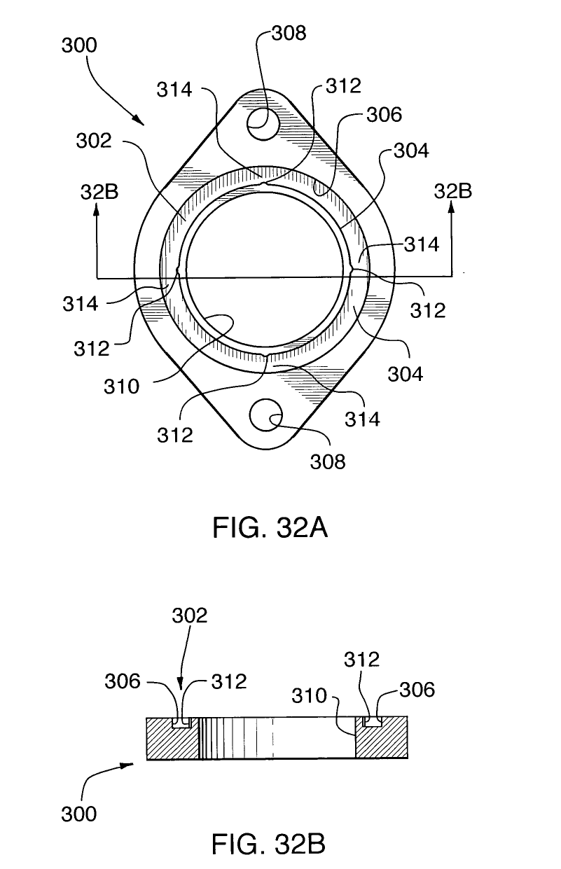

FIGS. 32A and 32B show an alternative embodiment of a unisex flange 300 having an annular gasket recess 302 comprising an inner wall 304 and an outer wall 306 with the inner wall having an inner diameter 310. At least one protrusion 312 is arranged along the inner wall 304 or the outer wall 306 to form at least one squeeze area 314, where the width of the gasket recess is substantially narrower than a maximum gasket recess width so that the gasket is held in the gasket recess after insertion. Preferably, multiple squeeze areas 314 are defined in the gasket recess 302 by multiple protrusions 312 on the inner wall 304. The flange 300 further comprises mounting holes 308. FIG. 32B is a cross-sectional view taken along the line 32B-32B of FIG. 32A.

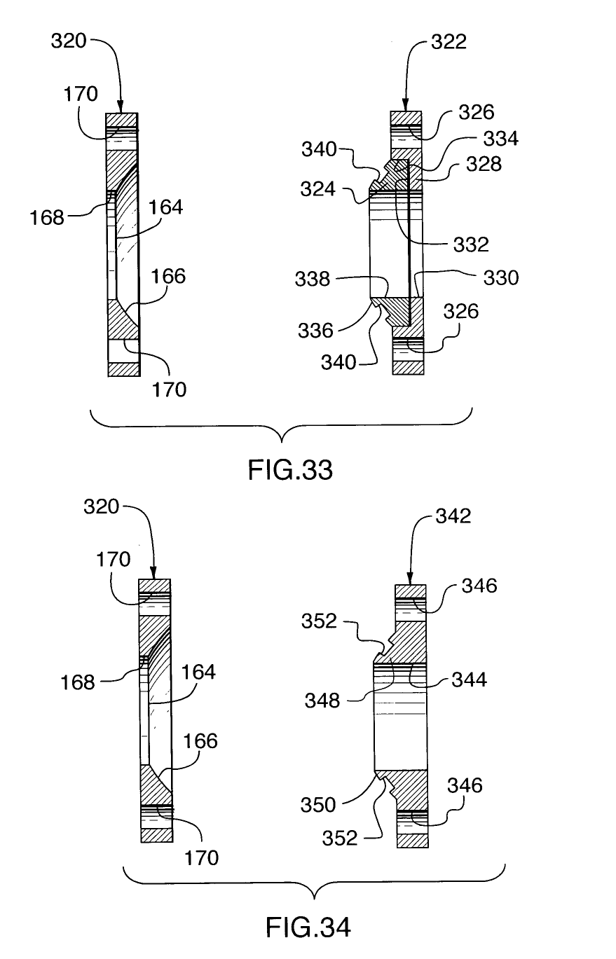

FIG. 33 shows a further embodiment of an exhaust flange assembly similar to the embodiment shown in FIGS. 30A and 30B. The exhaust flange assembly comprises a first flange 320 and a second flange 322. The first flange 320 is similar to the first flange 152 described with respect to FIG. 27 while the second flange 322 has mounting holes 326 and a backing plate portion 328 arranged on the side of the flange opposite the gasket 324. The backing plate portion 328 has an inner diameter 330 and an inner surface 332, facing away from the flange gasket 324. The first flange 320 has a general inner diameter 334, which is larger than the inner diameter 330 of the backing plate portion 328. A composite gasket element 324 is bonded to the second flange 322. The composite gasket element 324 is located between the first flange 320 and the second flange 322. The composite gasket element 324 has a curved surface 336, generally conforming in shape to the recess 164 and sloping side walls 166 of the first flange 320. The composite gasket element has an inner diameter 338, substantially the same as the inner diameters 330 and 168. Additionally, the composite gasket element 324 has a gasket recess 340 arranged on the curved surface 336, to receive an additional annular sealing gasket (not shown).

FIG. 34 shows still a further embodiment of an exhaust flange assembly similar to the embodiment shown in FIG. 33. The first flange 320 of FIG. 34 is the same as the first flange 320 of FIG. 33. A second flange 342 comprises an inner diameter 344, mounting holes 346 and a protrusion 348. The protrusion 348 has a curved surface 350 which cooperates with the first flange 320 in that it generally conforms in shape to the recess 164 of the first flange 320. Additionally, the protrusion 348 has a gasket recess 352 arranged on the curved surface 350, to receive an additional annular sealing gasket (not shown).

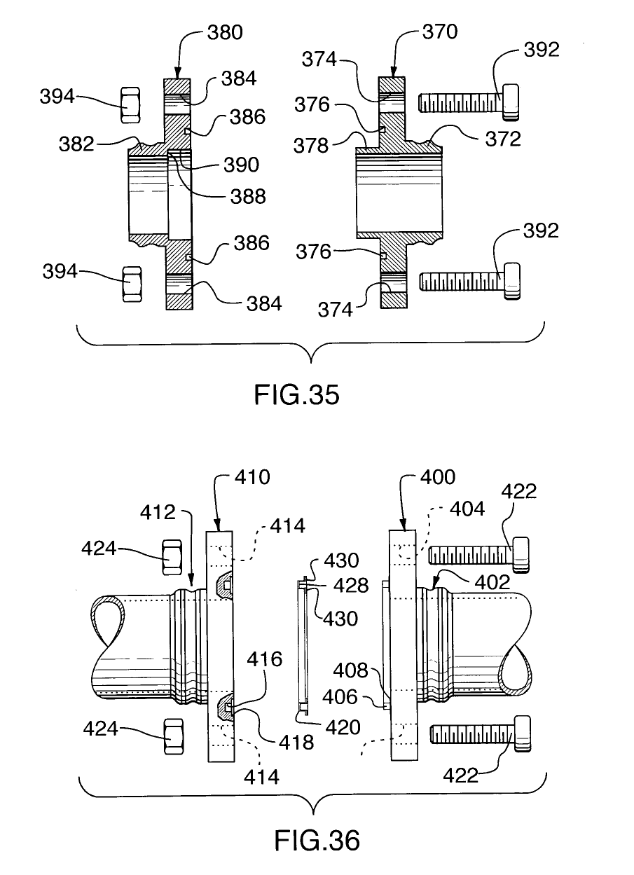

FIG. 35 shows yet a further embodiment of an exhaust flange assembly comprising a second flange, seen as an inner flange, 370 with an exhaust mounting extension 372, mounting holes 374, gasket recesses 376 and a sealing extension 378. A first flange, seen as an outer flange, 380 has an exhaust mounting extension 382, mounting holes 384, gasket recesses 386 and a sealing recess 388 having an outer diameter 390 substantially corresponding to the outer diameter of the sealing extension 378. The sealing extension 378 and the sealing recess 388 thus cooperate to provide a seal when the flanges are mated as well as enhanced alignment assistant between the two flanges. The flanges are fastened together using fastening means comprising bolts 392 and nuts 394 with a gasket located between the two flanges. The sealing extension 378 adds rigidity to the flange joint and maintains pipe alignment when the flanges are mated. Exhaust pipes are connected to the mounting extensions 372 and 382 using a roll-forming process as described above.

FIG. 36 shows yet a further embodiment of an exhaust flange assembly. The assembly comprises a second flange 400, seen as an inner flange, comprising an exhaust mounting extension 402, mounting holes 404 and an annular gasket holding ridge 406 with a base 408 and a first flange 410, seen as an outer flange, comprises an exhaust mounting extension 412, mounting holes 414 and an annular gasket holding recess 416 with an annular ring 418. The gasket holding ridge 406 and the gasket holding recess 416 thus cooperate to positively hold a shaped gasket 420 to provide a positive seal and enhanced alignment between the two flanges 400 and 410. The flanges 400 and 410 are fastened together using fastening means such as bolts 422 and nuts 424.

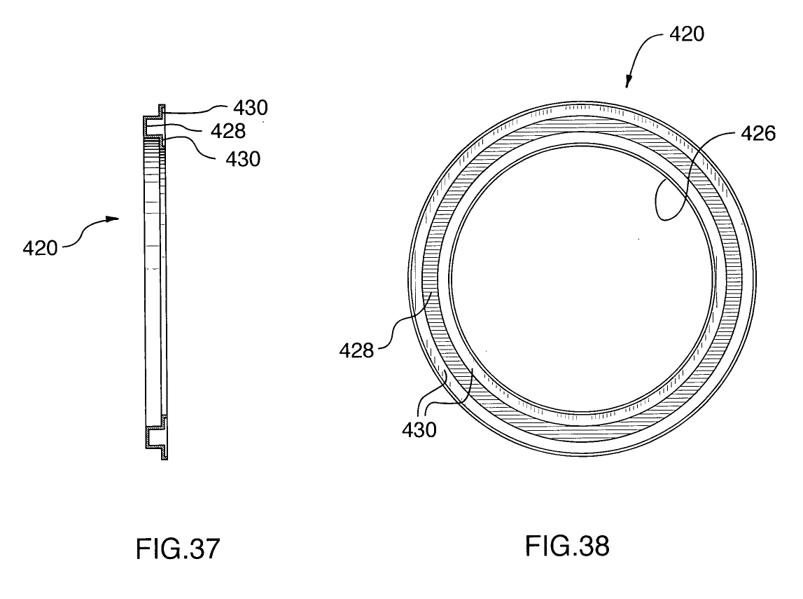

FIGS. 37 and 38 provide detailed schematic views of the shaped gasket 420. The gasket 420 comprises a gasket inner diameter 426, which is substantially the same or larger than the inner diameters of the exhaust openings of the flanges. The gasket holding ridges 416 mate with a gasket ridge holder 428 while the other end of the gasket ridge holder 428 rests in the gasket holding recess. The gasket ridge holder 428 comprises an edge 430. The gasket has five sealing surfaces on its “hat”-like cross-section (brim, side, top, other side and other brim), and this shape gives no direct escape for gases. The gasket is made of a resilient material, and preferably laminated and/or spirally wound.

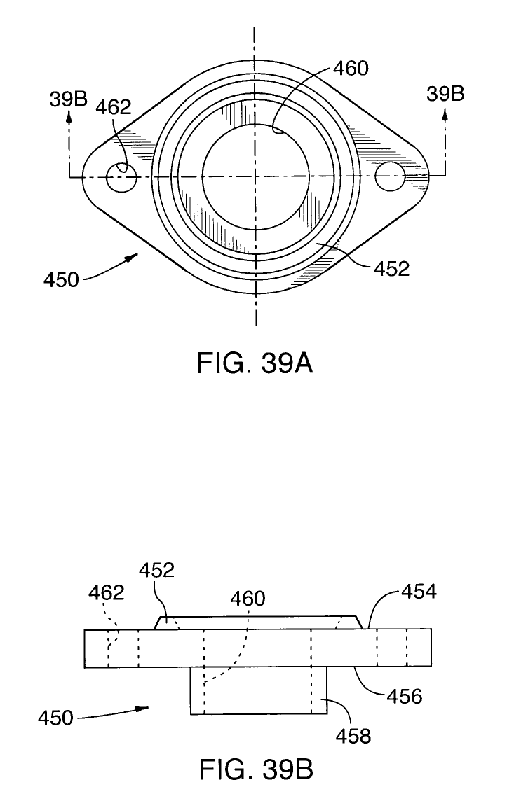

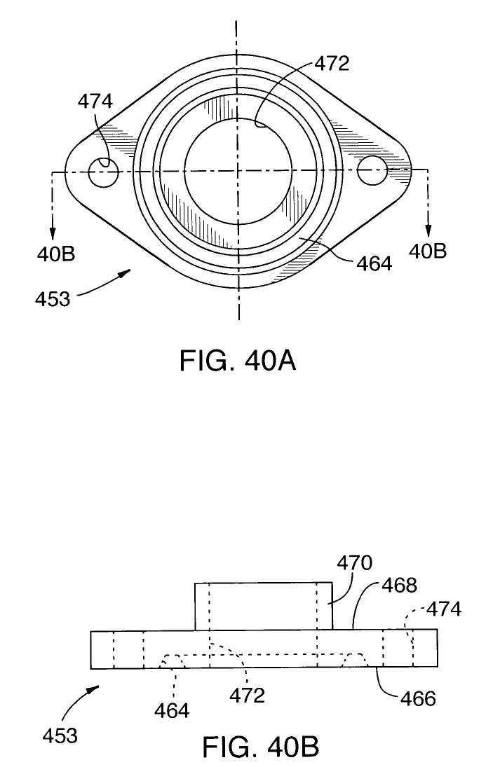

FIGS. 39A to 42 show a further embodiment of a flange joint. FIGS. 39A and 39B are schematics of an outer flange 450 comprising a conical rib 452 on a sealing surface 454 of the outer flange 450 which cooperates with a conical recess 464 of an inner flange 453 (as shown in FIGS. 40A and 40B). The outer flange 450 further comprises a pipe attachment surface 456 having a pipe attachment means 458. An exhaust through hole 460 is arranged in the outer flange 450 for passage of exhaust gas when the flange is assembled as part of the exhaust system flange joint. Mounting holes 462 are also arranged through the outer flange 450.

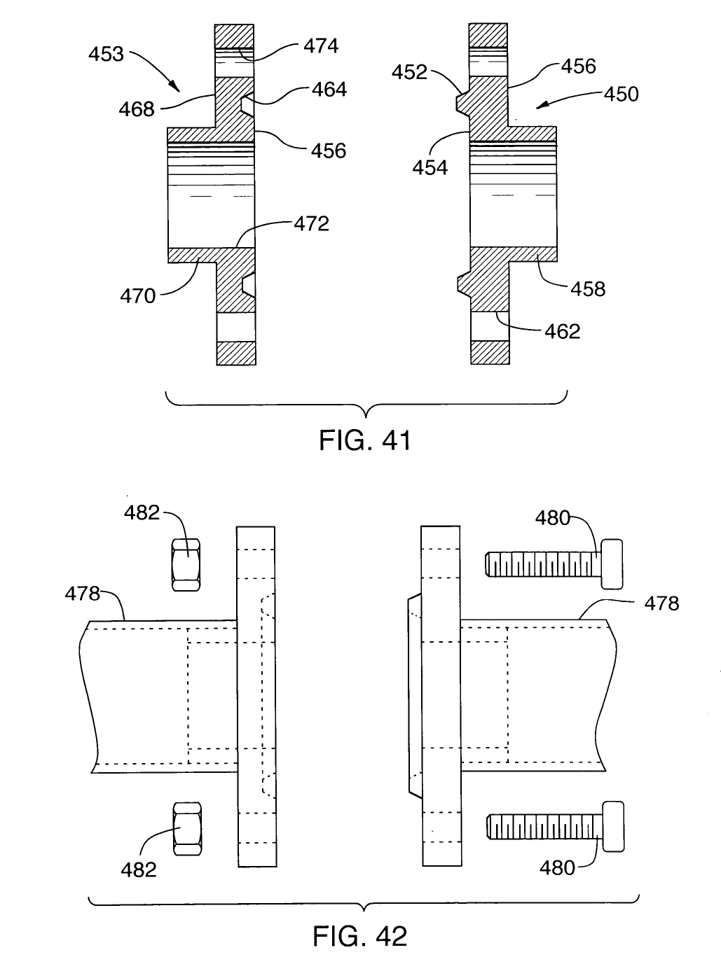

The inner flange 453 comprises a conical recess 464 on a sealing surface 466 of the inner flange 453. The inner flange 453 further has a pipe attachment surface 468 having a pipe attachment means 470. An exhaust through hole 472 is arranged in the inner flange 453, for passage of exhaust gas when the flange 453 is assembled as part of an exhaust system flange joint. Mounting holes 474 are also arranged through the outer flange. FIG. 41 shows an exhaust flange assembly comprising the mating of the outer flange 450 and the inner flange 453 while FIG. 42 shows the exhaust flange assembly of FIG. 41, with the outer flange 450 and the inner flange 453 joined to respective pipes 478 with connecting bolts 480 and nuts 482 used to draw the two flanges together. When the inner and the outer flanges 453 and 450, respectively, are fastened together, the conical rib 452 and the conical recess 466 form a compression fitting to eliminate leaks in the flange joint. The rigidity of the joint is also enhanced by the compression fitting of the invention.

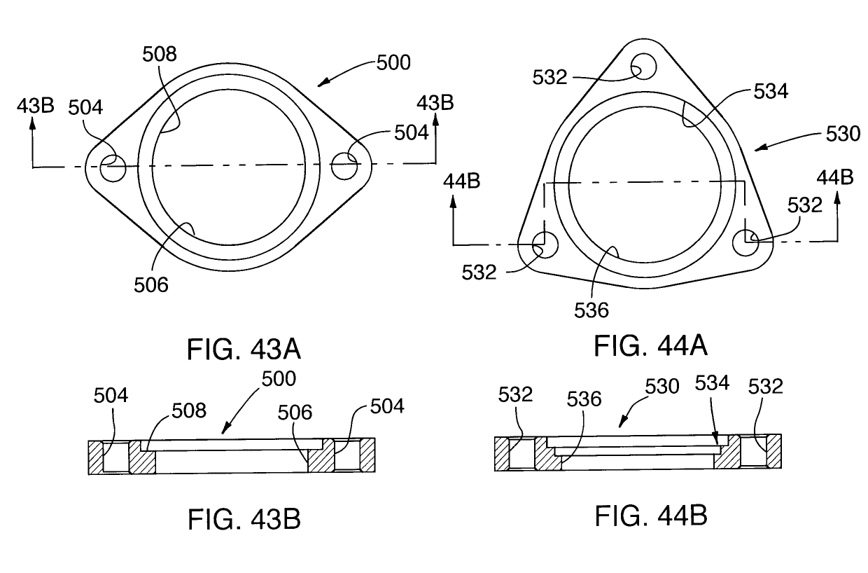

FIGS. 43A and 43B show a further embodiment of a second flange, or inner flange, while FIGS. 44A and 44B show yet another embodiment of an inner flange.

In FIGS. 43A and 43B, the inner flange 500 mates with an outer flange 502 which is identical to the outer flange 370 of FIG. 33. The inner flange 500 is manufactured in two parts and comprises a flat part (backing plate) which has mounting holes 504, a central through hole 506, a recess 508 with an end wall 510 and a sealing part 512. The flange material is preferably sintered material, possibly different material in the two different parts, for instance using material with enhanced sealing properties for the sealing part and material with enhanced strength for the backing plate. The sealing part 512 has an outwardly curved surface 514 generally corresponding to the recess 516 with sloping side walls 518 of the outer flange 502. The sealing part further has a recess 520 having an inner annular surface 522. The sealing part 512 also has an outer annular sealing surface 524. The sealing part 512 further has an inner diameter 526, smaller than the inner diameters (central through hole) 506 and 528, respectively, of the inner flange and the outer flange. The two parts of the inner flange 500 are made in separate pressing operations and assembled and bonded in a sintering process. The required press force is lower, making it possible to use smaller and cheaper presses. Both parts are optionally pre-sintered at relatively low temperatures and then pressed together and subjected to a final sintering step, during which the two parts bond together. When the two parts are pressed together, the inner flange recess 508 contacts the sealing part recess 520, and the inner flange recess end wall 510 contacts the outer annular sealing surface 524, whilst the sealing part inner annular surface 522 contacts the surface of the central through hole 506, forming mating surfaces for the two parts. Thus, the inner flange recess has a shape cooperating with and corresponding to the shape of the sealing part recess. For the two-piece inner flange described above, a bonding agent/welding flux may be applied to the mating surfaces after an optional pre-sintering step but before final sintering, to enhance the bond between the two parts after sintering. Further, an optional weld may be applied to the inner flange after sintering, to additionally strengthen the joint between the sealing part and the backing plate. The weld would be applied on the side of the inner flange where the sealing part extends from the backing plate, and either be in the form of a tack weld or a continuous weld along the full joint between the sealing part and the backing plate.

As is shown in FIGS. 43A and 43B, the inner flange 500 may have two mounting holes 504 and a single step recess 508, as described above.

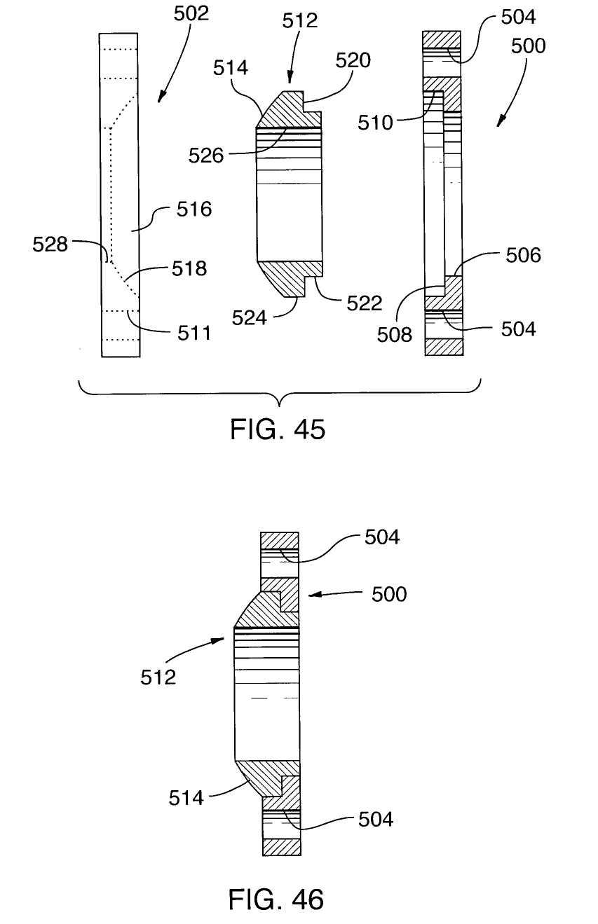

An alternative embodiment of an inner flange 530 is shown in FIGS. 44A and 44B. The inner flange 530 has three mounting holes 532 and a multi-stepped recess 534 corresponding in shape to a multi-stepped recess of the sealing part (not shown). The larger number of mounting holes makes a secure attachment of the inner flange and a outer flange easier, and the multi-stepped recess enlarges the surface area between the two parts of the inner flange, which enhances the bonding between the two parts after final sintering. The inner flange 530 further comprises a centre through hole 536. It will be understood that the inner flange 530 may also be used in the exhaust flange assembly of FIG. 45.

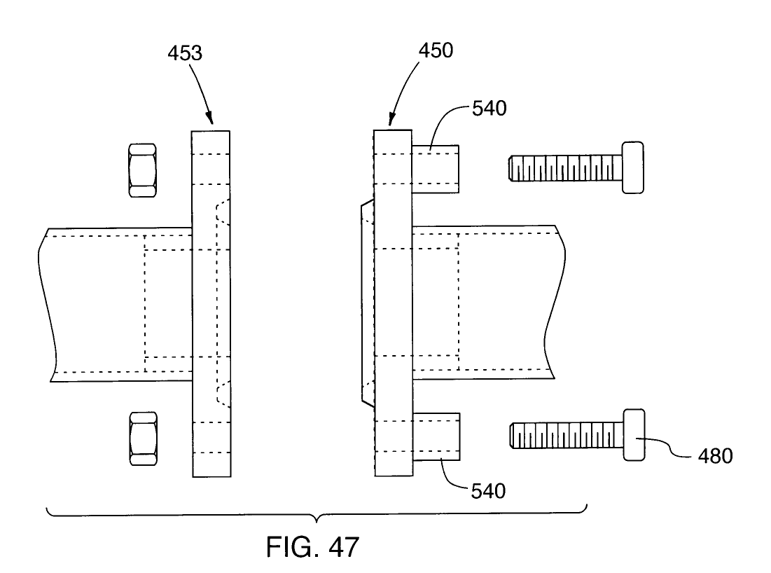

Turning to FIG. 47, an exhaust flange assembly, similar to the exhaust flange assembly described with respect to FIG. 42 is shown. The outer flange 453 is identical to the outer flange 453 described in FIG. 42 while the inner flange 450 includes a pair of integral stand-offs 540 which receive the fastening means 480 and provide support to the fastening means.

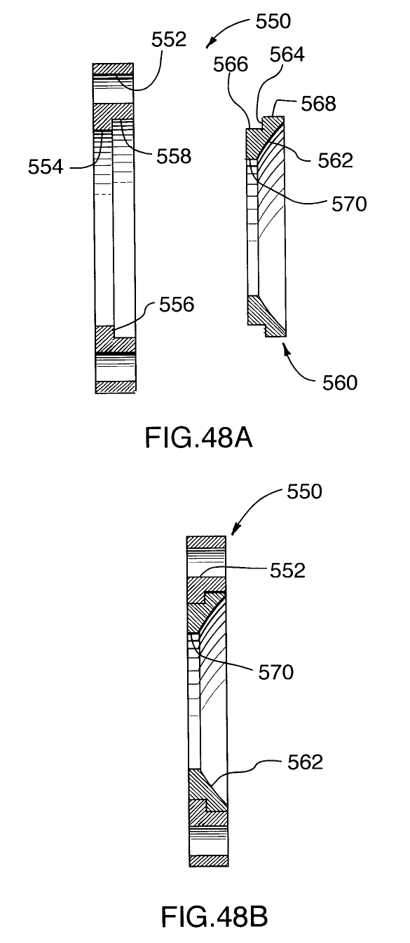

As is shown in FIGS. 48A and 48B, an outer flange 550 may be of two-piece construction (as outlined in FIGS. 43A to 46). The outer flange 550 comprises a flat part (backing plate) which has mounting holes 552, a central through hole 554 and a recess 556 with an end wall 558, and a sealing part 560. The flange material is preferably sintered material, possibly different material in the two different parts, for instance using material with enhanced sealing properties for the sealing part and material with enhanced strength for the backing plate. The sealing part 560 has an inwardly curved surface 562. The sealing part further has a recess 564 having an inner annular surface 566 and an outer annular surface 568. The sealing part 560 further has an inner diameter 570, smaller than the central through hole 554. The two parts of the outer flange 550 are made in separate pressing operations of a sintering manufacturing process. The required press force is lower, making it possible to use smaller and cheaper presses. Both parts are optionally pre-sintered at relatively low temperatures and then pressed together and subjected to a final sintering step, during which the two parts bond together. When the two parts are pressed together, the outer flange recess 556 contacts the sealing part recess 564, and the outer flange recess end wall 558 contacts the outer annular sealing surface 568, whilst the sealing part inner annular surface 566 contacts the surface of the central through hole 554, forming mating surfaces for the two parts. Thus, the outer flange recess has a shape cooperating with and corresponding to the shape of the sealing part recess. For the two-piece outer flange described above, a bonding agent/welding flux may be applied to the mating surfaces after an optional pre-sintering step but before final sintering, to enhance the bond between the two parts after sintering. Further, an optional weld may be applied to the outer flange after sintering, to additionally strengthen the joint between the sealing part and the backing plate. The weld would be applied on the side of the outer flange where the sealing part extends from the backing plate, and either be in the form of a tack weld or a continuous weld along the full joint between the sealing part and the backing plate.

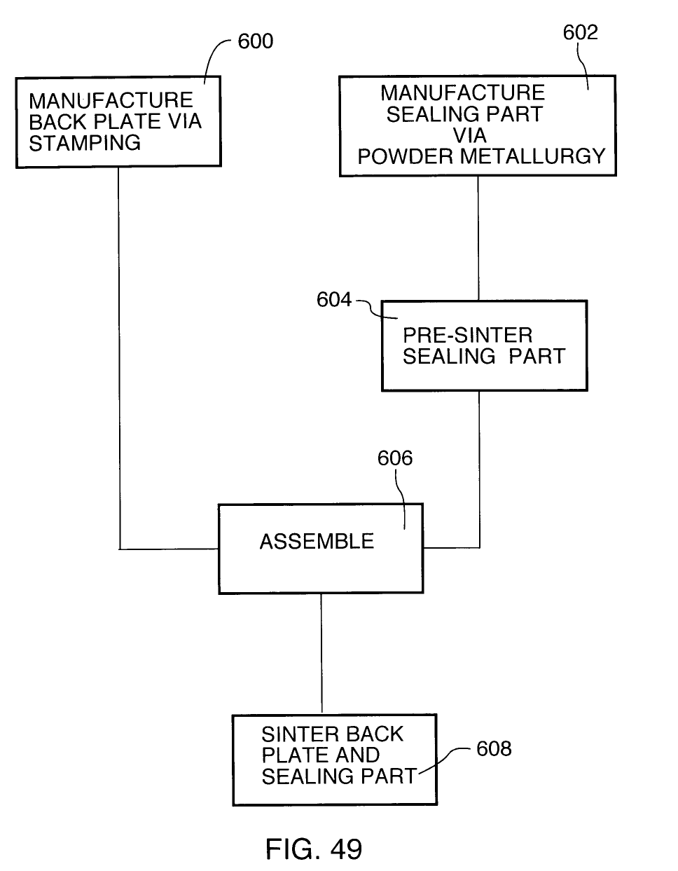

Turning to FIGS. 49 to 52, flow charts outlining methods of manufacturing the various embodiments of the flanges are shown. In the method of FIG. 49, the back plate of the flange is manufactured using a stamping process (step 600) while the sealing part (the recess or the rounded edge) of the flange is manufactured using a powder metallurgy process (step 602). After the sealing part of the flange is manufactured, the sealing part is pre-sintered (step 604). The sealing part and the back plate are then placed in contact and sintered together (step 606) and assembled as a flange (step 608).

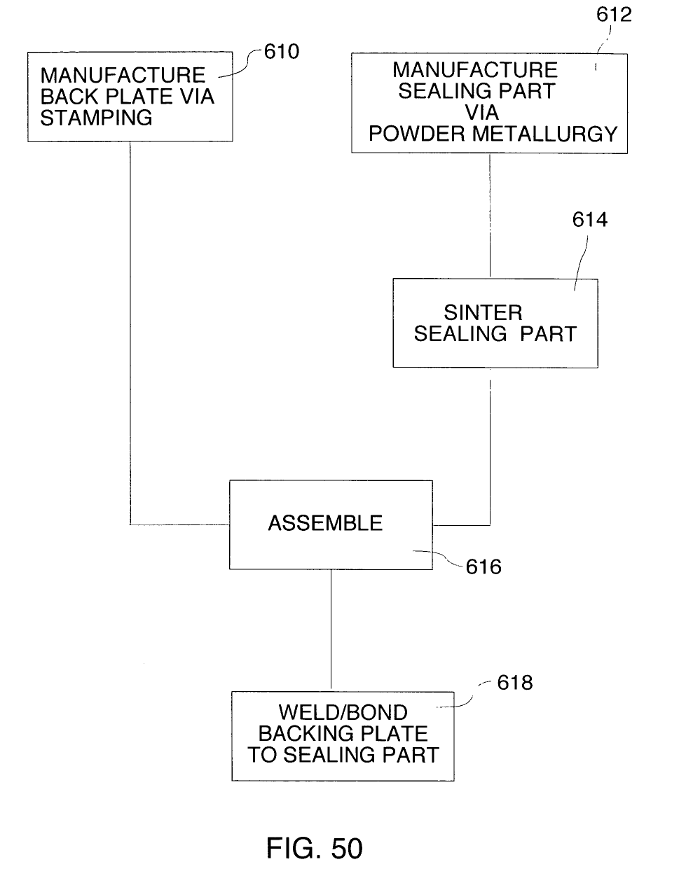

In the method of FIG. 50, the back plate is manufactured using a stamping process (step 610) while the sealing part is manufactured using a powder metallurgy process (step 612) and then sintered (step 614). After the sealing part is sintered, the back plate and the sealing part are assembled (step 616) and then welded or bonded together to form the flange (step 618).

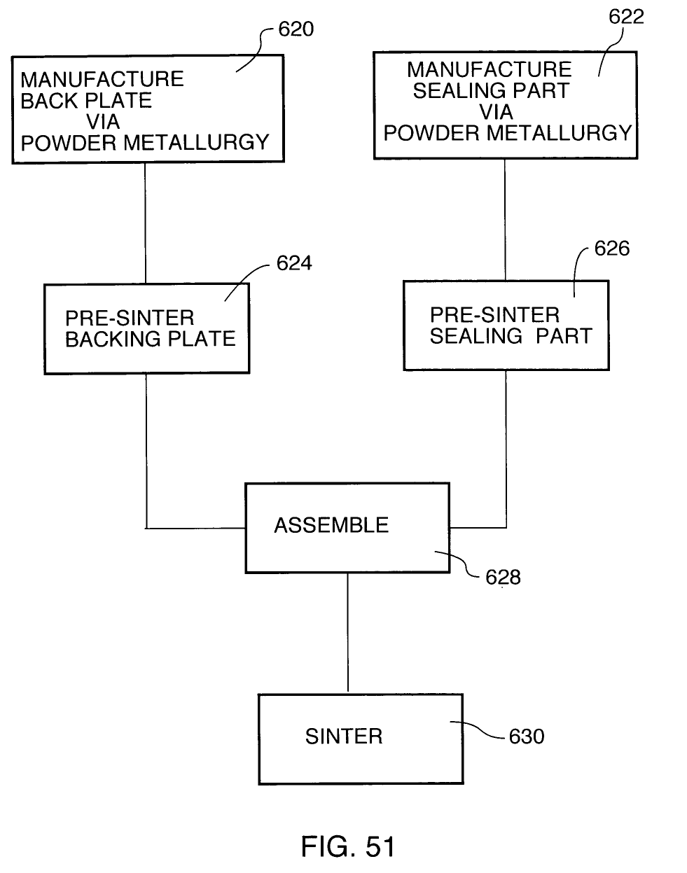

In the method of FIG. 51, the back plate and the sealing part are both manufactured using a powder metallurgy process (steps 620 and 622) and then pre-sintered (steps 624 and 626). After being pre-sintered, both the back plate and the sealing part are assembled together (step 628) and then sintered together to form the flange (step 630).

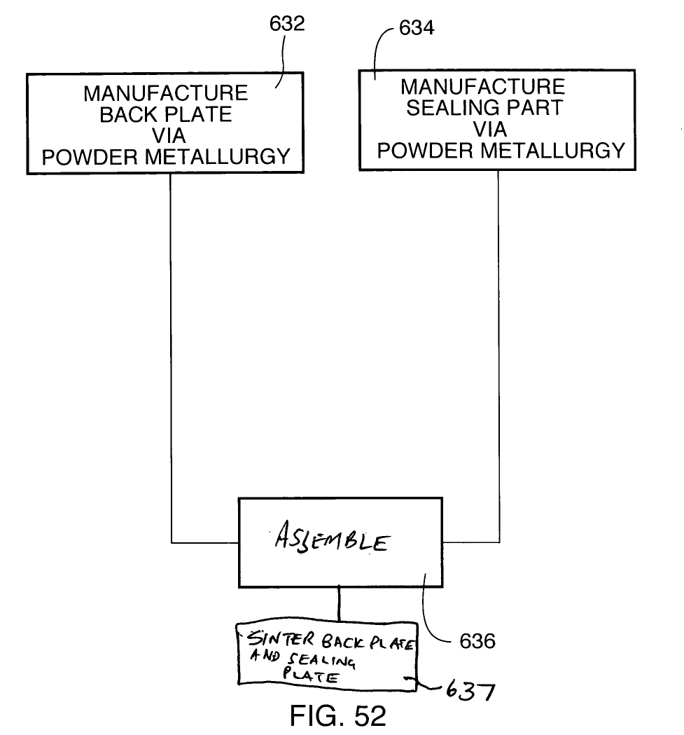

In the method of FIG. 52, both the back plate and the sealing part are manufactured via a powder metallurgy process (steps 632 and 634), assembled (step 636) and then placed in contact and sintered together to form the flange (step 637).

During the manufacture of the sealing part via a powder metallurgy process, the material of the sealing part may be selected to minimize the co-efficient of expansion to reduce the wear on a gasket if a gasket is required.

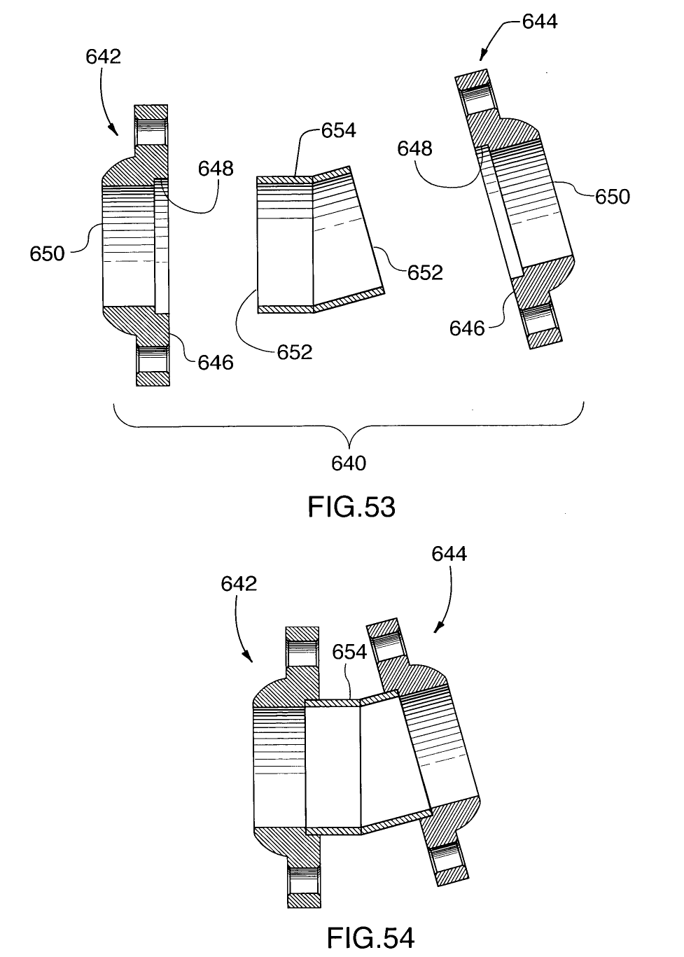

FIGS. 53 to 62 provide yet further embodiments of exhaust flange assemblies in which an angled flange assembly is provided whereby the angle is between a longitudinal direction of an exhaust pipe and the flange itself.

In the embodiment shown in FIGS. 53 and 54, the flange assembly 640 comprises a first flange 642 and a second flange 644. Both of the flanges 642 and 644 comprise a substantially flat edge 646 (having a recess 648) and a spherical end 650. Each recess 640 is shaped to receive one end 652 of an angled exhaust pipe 654. The ends 652 of the angled exhaust pipe 654 are generally connected to the recesses 640 of the flanges 642 and 644 by welding, brazing or other known bonding processes to manufacture a flange assembly having a pre-determined angle between the mounting faces of the flanges. FIG. 54 shows a flange assembly with the flanges connected to the angled exhaust pipe.

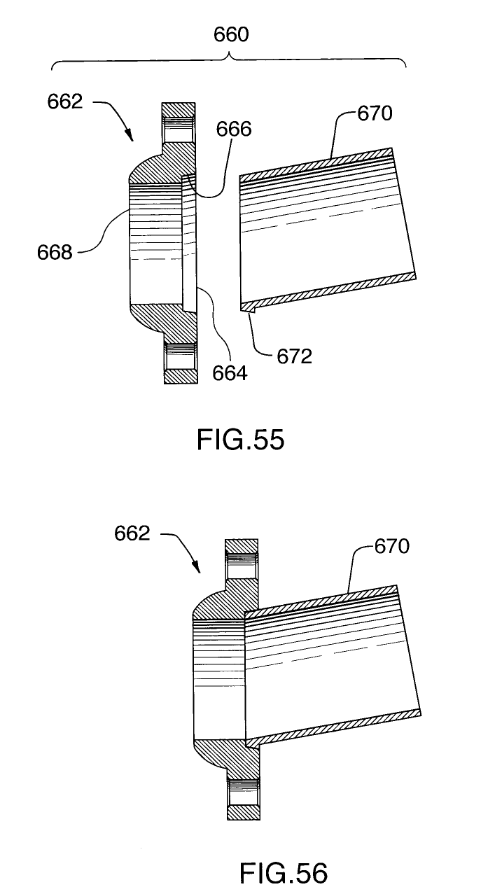

Turning to FIGS. 55 and 56, another flange assembly 660 comprising a flange 662 having a flat edge 664 with a recess 666 and a spherical edge 668 is shown. The recess 666 is frusto-conical, seen as a truncated cone, allowing an exhaust pipe 670 with an angled end, i.e. the end is not perpendicular to a longitudinal direction of the pipe, to be inserted and fastened to the flange 662. A shoulder 672 is arranged on the pipe 670 so that, after the pipe 670 has been fastened to the flange 662, there is little or no gap between the flange 662 and the pipe 670 so that exhaust does not leak from the flange assembly during use.

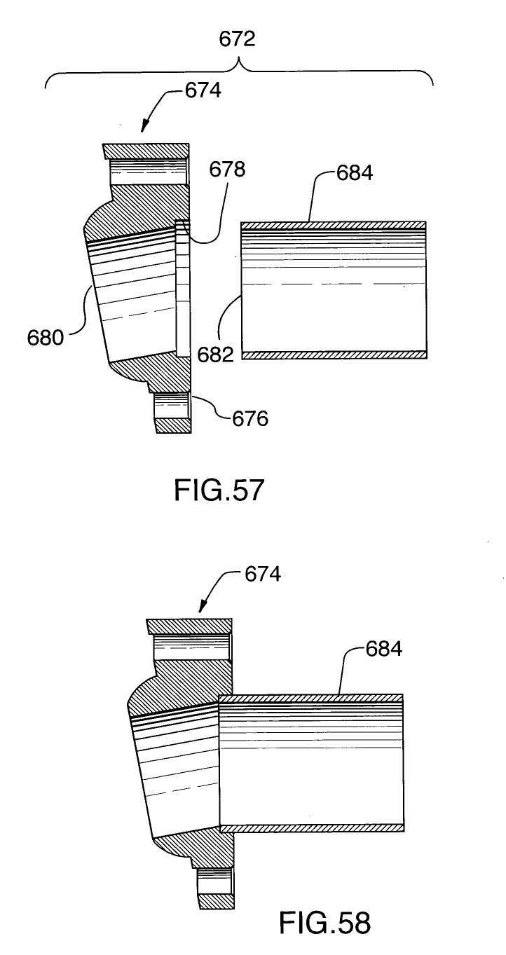

Turning to FIGS. 57 and 58, yet a further angled flange assembly is shown. The flange assembly 672 comprises a flange 674 having a flat edge 676 with a recess 678 and a spherical edge 680 is shown. In this embodiment, the flange 672 is angled with the recess 678 adapted to receive an end 682 of the exhaust pipe 684. The angle in the flange 674 is provided so that non-linear connections may be achieved in the exhaust system. The pipe 684 is fastened to the flange 674 by a method such as welding.

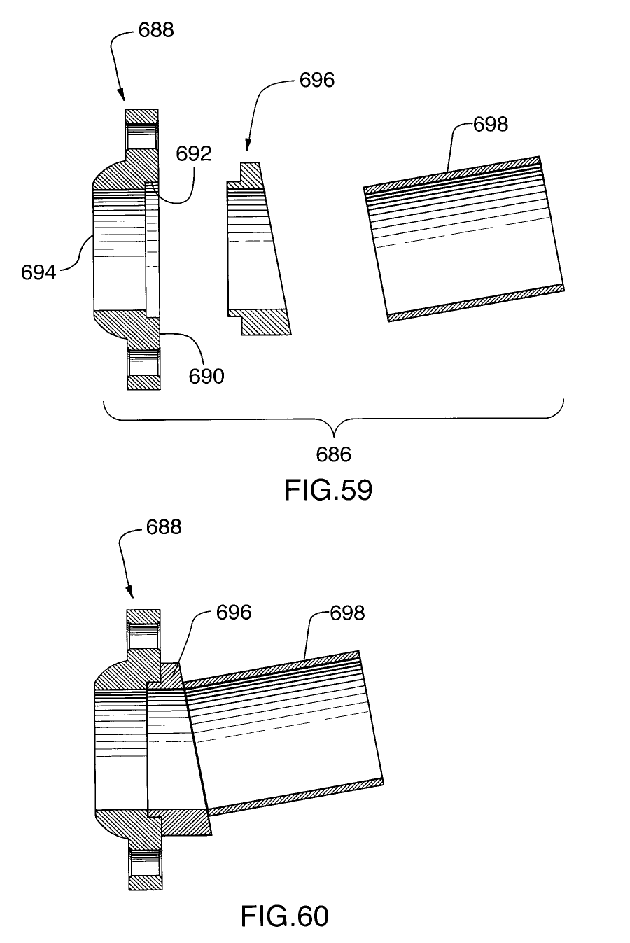

Turning to FIGS. 59 and 60, another angled flange assembly 686 is shown comprising a flange 688 comprising a flat edge 690 having a recess 692 and a spherical edge 694 is shown. The flange assembly 686 further comprises an angled portion 696. Both the flange 688 and the angled portion 696 are advantageously manufactured via a powder metallurgy process and are sintered together after optional pre-sintering steps. The desired angle of the flange assembly is thus provided by the angled portion 696. An exhaust pipe 698 is fastened to the angled portion 696 either by welding or brazing. Alternatively, the pipe 698 may be inserted in a recess in the angled portion 696 (not shown).

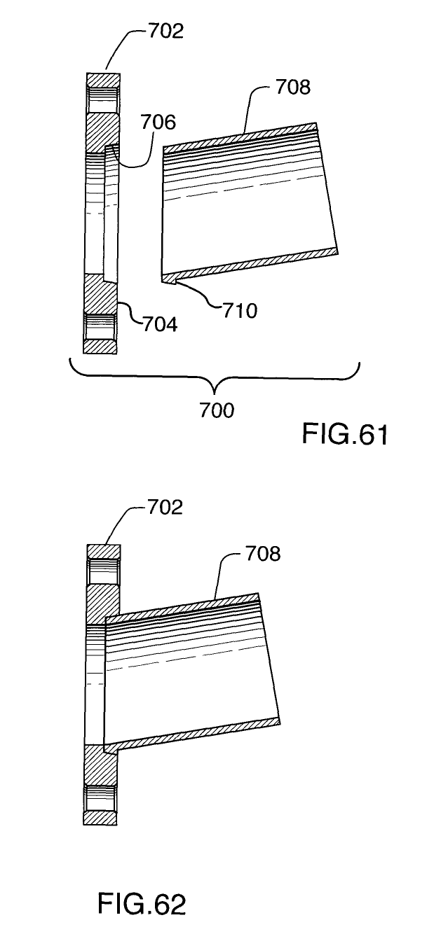

Turning to FIGS. 61 and 62, an angled flange assembly 700 comprising a flange 702 having a mating edge 704 with a recess 706 for receiving a an exhaust pipe 708 having a shoulder 710 is shown. The exhaust pipe is attached to the flange via press-fitting, spinning, resistance welding, crimp rolling or other known processes.

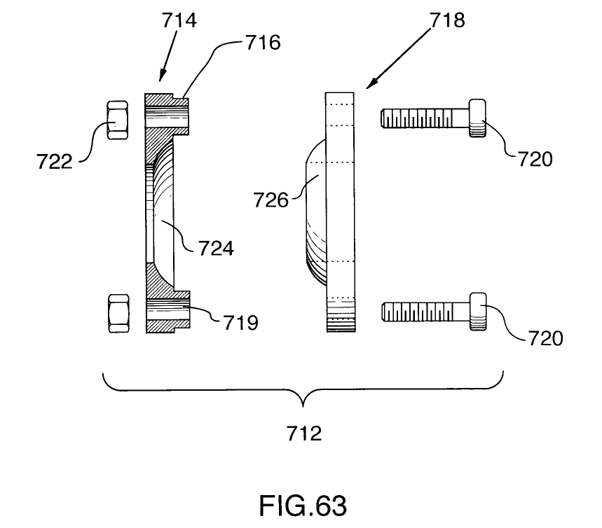

Turning to FIG. 63, a further embodiment of an exhaust flange assembly in accordance with the present invention is shown. The flange assembly 712 comprises a first flange 714 formed with a pair of integral spacers 716 using a powder metallurgical process and a second flange 718. The first flange 714 further comprises a pair of holes 719 for receiving fastening means, in the form of bolts 720, which assist in securing the connection between the flanges 714 and 718 when they are mated. The bolts 720 are secured by individual nuts 722. The spacers assist in aligning the two flanges when they are to be mated.

The first flange 714 further comprises a recess 724 for receiving a complementary shaped abutment 726 located on the surface of the second flange 718 to assist in the mating process to align the flanges 714 and 718.

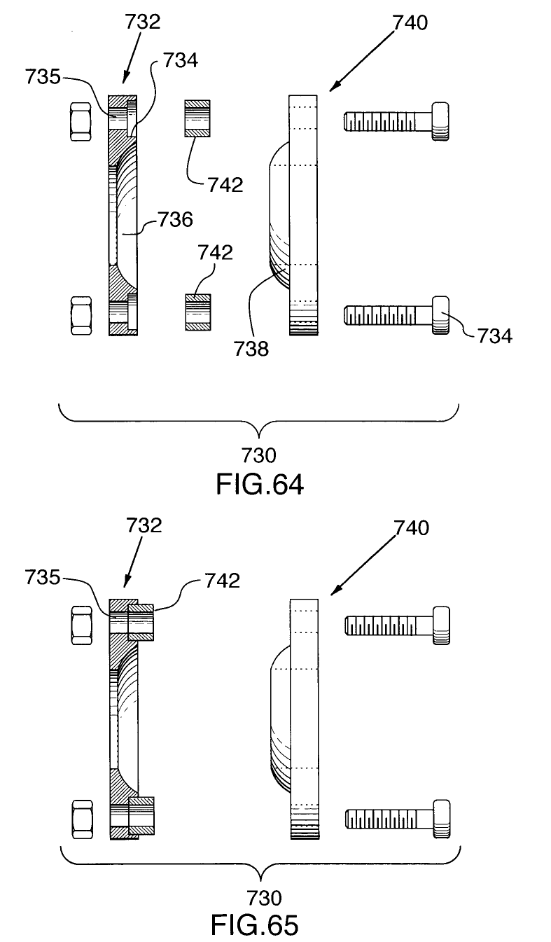

Turning to FIGS. 64 and 65, another embodiment of a flange assembly is shown. In this embodiment, the flange assembly 730 includes a first flange 732 comprising a pair of spacer recesses 734 connected to mounting holes 735 for receiving fastening means, in the form of a bolt 734, and a recess 736 for receiving a complementary shaped abutment 738 on a second flange 740. Spacers 742, preferably manufactured using a pressing process, are inserted into the pair of spacer recesses 734 and fastened to the first flange 732 via sintering. After the bolts 732 are inserted into the spacer recesses 734 and the spacers 742, nuts 744 are used to secure the connection between the two flanges by tightening them on the bolts.

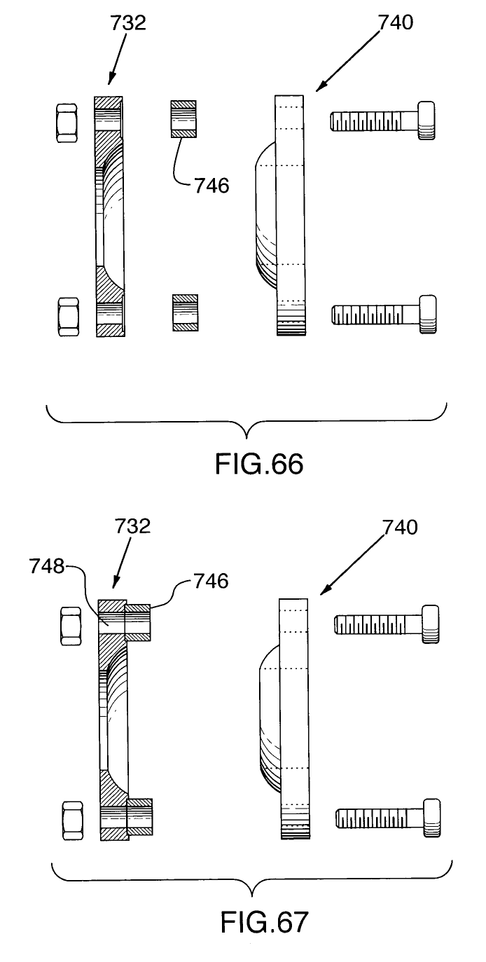

Alternatively, as shown in FIGS. 66 and 67, the spacers 746 may be aligned with the mounting holes 748 and held in place during the sintering process.

In the embodiments shown in FIGS. 64 to 67, a brazing alloy may advantageously be used between the spacer and the first flange to improve the bonding between the two parts. Furthermore, the spacers and/or the flange may be pre-sintered and assembled before the final sintering process.

Advantageously, the present invention overcomes some of the problems in prior art exhaust flange assemblies. Firstly, by using a powder metallurgy process to manufacture the flanges, more complex flange shapes may be achieved. Also, the powder metallurgy process is also less expensive than some of the methods in the prior art.

Moreover, the embodiments of the present invention also reduces or eliminates the amount of exhaust which escapes into the atmosphere by providing mating surfaces on the flanges which are complementary to each other. This also assists in providing alignment to the flanges. Also, the use of spacers allows for further alignment of the flanges. Use of ribs or through holes also allows for a flange that is lighter than some prior art flanges.

When gaskets are required, the mating surfaces of the flanges assist in retaining the gaskets so that they do not fall out during assembly of the exhaust flange assembly. This may also be assisted by integral fastening means which are manufactured as part of the flange so that there is less opportunity for the fastening means to slip out during assembly.

The invention provides a number of advantages, which include that the use of powdered metal permits reduced thickness and weight by permitting the use of reinforcing ribs or the formed tightening holes, that the sealing configuration avoids a direct escape path for exhaust gases, thereby potentially reducing the need for gaskets and potentially reducing emissions and to facilitate the alignment of the different parts of the exhaust system.

Preferably, the outer flange is made of one material and the inner flange is made of another material. In this way, the heat expansion of the flange can be regulated to compensate for differences in heating of the flanges (the flange closest to the engine will theoretically be heated more than the flange further away). By choosing a material having a lower heat expansion for the flange closest to the engine, and a material having a higher heat expansion for the other flange, both flanges can be made to expand equally much during use, thus enhancing the fit and seal of the flange assembly.

Preferably, the materials used for making the flanges contain between 0.75 to 1 weight percent of hexagonal boron nitride (BN), which enhances the corrosion resistance properties of the powder metallurgical materials used, as disclosed in U.S. Pat. No. 6,103,185.

Using flanges as described in the different embodiments of the invention will enhance the sealing and rigidity properties of the flange joint, compared to known flange assemblies.

The invention provides a number of advantages such as the inclusion of integral mounting studs avoid the need for separate studs, that the use of powdered metal permits reduced thickness and weight by permitting the use of reinforcing ribs and that the sealing configuration avoids a direct escape path for exhaust gases, thereby potentially reducing the need for gaskets and potentially reducing emissions.

Furthermore, when assembling exhaust pipes it might be economical to use standard length bolts, which might be too long for the application and possibly interfere with the pipe if it has a sharp bend adjacent the flange. To accommodate longer bolts, it is foreseen to produce the sintered flanges having a stand-off sleeve integrally formed on the surface of the flange which faces away from the sealing surface of the flange, as shown in FIG. 47. When using a two-piece flange, having a separate sealing part, the two parts may be fixed to each other by low-strength glue, or similar, to secure the sealing part in place until the flange is used with another flange to form a flange assembly. After the flanges are joined, the sealing part will be held in place by the joining forces.

As will be understood, although not expressly shown in each figure, it will be understood that each of the flanges comprises means for attaching to an exhaust pipe.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An automotive exhaust flange assembly for attaching exhaust pipes, said assembly comprising:
a first flange, made of powder metallurgically produced material, comprising a mating surface and a pipe attachment surface opposite said mating surface; and
a second flange, made of powder metallurgically produced material, comprising a sealing surface complementary to said mating surface of said first flange and a pipe attachment surface opposite said sealing surface;
wherein said first flange or said second flange further comprises gasket retention means through mechanical interference to provide squeeze areas.

2. The flange assembly of claim 1 wherein the gasket retention means is an oval annular recess.

3. The flange assembly of claim 1 wherein the gasket retention means is a notched annular recess.

4. The flange assembly of claim 1 wherein said first flange further comprises a set of ribs within said pipe attachment surface for reducing the weight of said first flange.

5. The flange assembly of claim 1 wherein said second flange further comprises a set of ribs within said pipe attachment surface for reducing the weight of said second flange.

6. An automotive exhaust flange assembly for attaching exhaust pipes, said assembly comprising:
a first flange, made of powder metallurgically produced material, comprising a mating surface and a pipe attachment surface opposite said mating surface; and
a second flange, made of powder metallurgically produced material, comprising a sealing surface complementary to said mating surface of said first flange and a pipe attachment surface opposite said sealing surface;
wherein one of said first or second flange further comprises at least one concave recess for accepting fastening means to secure said first and second flanges when mated.

7. The flange assembly of claim 6 wherein said at least one concave recess comprises a hexagonal portion at one end.

8. The flange assembly of claim 6 wherein said fastening means comprises a hexagonal shoulder.

9. An automotive exhaust flange assembly for attaching exhaust pipes, said assembly comprising:
a first flange, made of powder metallurgically produced material, comprising a first surface having a cavity and a pipe attachment surface opposite said first surface; and
a second flange, made of powder metallurgically produced material, comprising a sealing surface complementary to said cavity and a pipe attachment surface opposite said sealing surface;
said second flange further comprises at least one integral stud for securing said second flange to said first flange when said flanges are mated.

10. An automotive exhaust flange assembly for attaching exhaust pipes, said assembly comprising:
a first flange, made of powder metallurgically produced material, comprising a mating surface and a pipe attachment surface opposite said mating surface; and
a second flange, made of powder metallurgically produced material, comprising a sealing surface complementary to said mating surface of said first flange and a pipe attachment surface opposite said sealing surface;
said first flange further comprising a hat-shaped annular recess for receiving a hat-shaped gasket.

11. The flange assembly of claim 10 wherein said second flange further comprises a protrusion corresponding to said hat-shaped annular recess of said first flange.

12. An automotive exhaust flange assembly for attaching exhaust pipes, said assembly comprising:
a first flange, made of powder metallurgically produced material, comprising a mating surface and a pipe attachment surface opposite said mating surface; and
a second flange, made of powder metallurgically produced material, comprising a sealing surface complementary to said mating surface of said first flange and a pipe attachment surface opposite said sealing surface;
said first flange comprising an v-shaped annular rib;
said second flange further comprising a v-shaped annular recess for receiving said annular rib.

13. The flange assembly of claim 12 wherein said first flange further comprises a pipe attachment means arranged on said pipe attachment surface of said first flange.

14. The flange assembly of claim 12 wherein said second flange further comprises a pipe attachment means arranged on said pipe attachment surface of said second flange.

15. An angled exhaust flange assembly comprising:
an exhaust pipe having a first and a second end;
a flange securable to an end of the pipe;
the first end of the pipe being angled a pre-determined amount away from the second end of the pipe so that an angled flange assembly is provided when the flange is fastened to the first end.

16. The angled exhaust flange assembly as recited in claim 15, wherein the predetermined amount is substantially 135 degrees.

17. The angled exhaust flange assembly as recited in claim 15, wherein a second flange is fastened to the second end of the pipe.

18. The angled exhaust flange assembly as recited in claim 15, wherein the flange is a spherical flange.

19. The exhaust flange assembly as recited in claim 17, wherein the second flange is a spherical flange.

20. An angled exhaust flange assembly comprising:
an exhaust pipe having a first and a second end;
a flange;
an angled portion, having a first end connected to the flange and a second end connected to the first end of the exhaust pipe for providing an angled exhaust flange assembly.

21. An exhaust flange assembly for sealingly connecting exhaust pipes to each other, said assembly comprising:
a female flange having a mating surface and a pipe attachment surface; and
a male flange having a mating surface and a pipe attachment surface;
where spacers are arranged on said pipe attachment surface of either said female flange or said male flange to provide a pre-determined minimum clearance between said pipe attachment surface and fastening means;
said spacers being integrally formed when the flange is manufactured via a powder metallurgy process.

22. The exhaust flange assembly as recited in claim 21, wherein the spacers are separately formed and bonded to the flange during a sintering operation.

23. A method of manufacturing an exhaust flange comprising the steps of:
manufacturing a back plate via a stamping process;
manufacturing a sealing part via a powder metallurgy process;
pre-sintering the sealing part;
sintering the back plate and the sealing part; and
assembling the back plate and the sealing part to form the exhaust flange.

24. A method of manufacturing an exhaust flange comprising the steps of:
manufacturing a back plate via a stamping process;
manufacturing a sealing part via a powder metallurgy process;
sintering the sealing part;
assembling the back plate and the sealing part; and
welding the back plate to the sealing part to form the exhaust flange.

25. A method of manufacturing an exhaust flange comprising the steps of:
manufacturing a back plate via a powder metallurgy process;
manufacturing a sealing part via a powder metallurgy process;
separately pre-sintering the backing plate and the sealing part;
assembling the back plate and the sealing part; and
sintering the back plate and the sealing part to form the exhaust flange.

26. A method of manufacturing an exhaust flange comprising the steps of:
manufacturing a back plate via a powder metallurgy process;
manufacturing a sealing part via a powder metallurgy process; and
sintering the back plate and the sealing part to form the exhaust flange.

27. An automotive exhaust flange assembly for attaching exhaust pipes, said assembly comprising:
a curved flange, made of powder metallurgically produced material; and
a straight flange, made of powder metallurgically produced material,
wherein when said curved and straight flanges are mated and secured by fastening means, said curved flange deflects towards to for a flat sealing surface between said curved and straight flanges.

28. A flange for use in a flange assembly comprising:
a sealing surface for mating with a sealing surface of a second flange and a pipe attachment surface;
said sealing surface comprising at least one raised area for reducing deflection of said flange when said flange is mated; and
a set of mounting holes for receiving fastening means securing mating of flange to said second flange.

29. A flange for use in a flange assembly comprising:
a sealing part comprising a cavity for receiving a complementary surface of a second flange; and
a back plate having a recess, in a first surface, for receiving and housing said sealing part and a second surface providing a pipe attachment surface.

30. The flange assembly of claim 1 wherein said first flange comprises 0.75 to 1 weight percent of hexagonal boron nitrate.

31. The flange assembly of claim 1 wherein said second flange comprises 0.75 to 1 weight of hexagonal boron nitrate.
